(19) United States
(12) Patent Application Publication
(10) Pub. No.: US 2024/0290957 A1
(43) Pub. Date: Aug. 29, 2024

(54) High Energy Density and High Power Density All-Solid-State Li Sulfur Batteries

(71) Applicant: Notheastern University, Boston, MA (US)

(72) Inventor: Hongli Zhu, Newton, MA (US)

(21) Appl. No.: 18/585,713

(22) Filed: Feb. 23, 2024

Related U.S. Application Data
(60) Provisional application No. 63/487,364, filed on Feb. 28, 2023.

(51) Int. Cl. H01M 4/36; H01M 4/02; H01M 4/58; H01M 4/587; H01M 10/0525; H01M 10/0562

(52) U.S. Cl. CPC H01M 4/366; H01M 4/5815; H01M 4/587; H01M 10/0525; H01M 10/0562; H01M 2004/021; H01M 2004/028; H01M 2300/008

(57) ABSTRACT

A MoS₂@polyacrylonitrile-derived porous carbon fiber core-shell structure for use in all-solid-state lithium-sulfur batteries (ASSLSBs) is disclosed. The core-shell structure comprises a core comprising polyacrylonitrile-derived porous carbon fibers (PPCF) with surface layer pores; and a shell comprising a MoS₂ nanosheet that is uniformly distributed on the surface of the core. Methods for making the core-shell structure are also disclosed, as well as methods of using the core-shell structure for ASSLSBs. The use of a MoS₂@PPCF core-shell structure in an ASSLSB resulted in improved electrochemical performance with ultrahigh specific capacity, high cycling stability, and high-capacity retention.

### RELATED APPLICATION

This application claims the benefit of U.S. Provisional Application No. 63/487,364 filed on Feb. 28, 2023. The entire teachings of the above application(s) are incorporated herein by reference.

### GOVERNMENT SUPPORT

This invention was made with government support under Grant Number 1924534 awarded by the National Science Foundation. The government has certain rights in the invention.

### BACKGROUND

Lithium-ion batteries (LiBs) play an important role in daily life, including portable electronics, electric vehicles, and large-scale grid storage.^{[1]} The US government sets a goal that 50% of new US vehicles should be electrically powered by 2030.^{[2]} However, commercial LiBs fabricated based on LiCoO₂ cathode, graphite anode, and organic liquid electrolyte show limited energy densities of 250 Wh kg⁻¹ and high safety risks.^{[3]} It is urgent to develop safe and high-energy-density batteries.

### SUMMARY

An advanced carbon fiber decorated with vertically grown 1T/2H MOS₂ nanosheets was designed to address the faced challenges in all-solid-state lithium-sulfur batteries (ASSLSBs), including the interface instability in sulfide solid-state electrolyte (SSE), the poor electronic and ionic conductivity, and the sluggish reaction kinetics. MoS₂, as metal sulfide, owns excellent chemical and electrochemical stability with both sulfur and sulfide SSEs. Therefore, the MoS₂ nanosheets grown on carbon fiber effectively prevent the severe decomposition of sulfide SSE under high voltage. The presence of electrically conductive 1T phase MoS₂ and its uniform distribution on carbon fiber without aggregation improve electron transfer efficiency. The unique layered structure of MoS₂ can be intercalated by a large amount of Li ions and therefore facilitate ionic conductivity. As a result, the cell which owns high ion and electron transport network delivered an ultrahigh initial discharge capacity of 1456 mAh g⁻¹, ultrahigh coulombic efficiency of ˜100%, high cycling stability with capacity retention of 78% over 220 cycles at 0.1 C, and outstanding rate performance of discharge capacity 1096 mAh g⁻¹ at 1 C. The stable interface without side reactions and eliminated shuttle effects contribute to the extremely high initial coulombic efficiency. In contrast, the carbon fibers without MoS₂ obtained the lower initial discharge of 1185 mAh g⁻¹ and the much poorer rate capacity of 220 mAh g⁻¹ at 1 C due to more inferior interface stability and limited ionic conductivity at interface from degradation products. This study revealed the significance of the interface stabilization and functionalization of carbon additives for high performance all-solid-state lithium-sulfur batteries.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-1G are schematic illustrations of the advantages of MoS₂ nanosheets cover on polyacrylonitrile-derived porous carbon fibers (PPCF) in the cathode. The configuration of the all-solid-state lithium-sulfur batteries (ASSLSBs) using (FIG. 1A) sulfur-polyacrylonitrile-derived porous carbon fibers-sulfide solid state electrolyte (S-PPCF-SSE) cathode and (FIG. 1D) S—MoS₂@PPCF-SSE cathode. The comparison of compatibility and stability with sulfide solid-state electrolyte (SSE) in the cathodes using (FIG. 1B) PPCF and (FIG. 1E) MOS₂@PPCF as carbon additives in ASSLSBs, individually. The charge transfer comparison in the cathodes using (FIG. 1C) PPCF and (FIG. 1F) MoS₂@PPCF as carbon additives in ASSLSBs, individually. FIG. 1G is the key to the components shown in FIGS. 1A-IF.

FIGS. 2A-2O show the morphology comparison between PPCF and MoS₂@PPCF. (FIG. 2A) The preparation of MoS₂@PPCF through electrospinning, thermo-treatment, and hydrothermal processes. (FIGS. 2B, 2C, 2D) scanning electron microscopy (SEM) images of PPCF under different magnifications. (FIGS. 2E, 2F, 2G) SEM image of vertical MoS₂@PPCF under different magnification. (FIGS. 2H, 2I, 2J) transition electron microscopy (TEM) images of vertical MoS₂@PPCF under different magnification. FIG. 2K) High-resolution TEM image of MoS₂@PPCF. (FIG. 2L) TEM image of MoS₂@PPCF and corresponding energy-dispersive X-ray spectroscopy (EDX) mapping of (FIG. 2M) C, (FIG. 2N) S, and (FIG. 2O) Mo elements.

FIGS. 3A-31 are material characterizations of MoS₂@PPCF. (FIG. 3A) The schematic of hybrid 1T/2H MOS₂. The crystal structures of (FIG. 3B) metallic 1T-MoS₂ phase with trigonal lattice geometry and (FIG. 3C) 2H—MoS₂ phase with common honeycomb lattice geometry. The light gray, exterior and dark gray, interior balls represent S and Mo atoms, respectively. (FIG. 3D) TEM images of the hybrid MoS₂ 1T and 2H structures. HRTEM images of the MoS₂ in (FIG. 3E) 1T and (FIG. 3F) 2H phases. The circled light gray dots were used to illustrate the atom arrangement of S. (FIGS. 3E and 3F) Raman spectra of the MoS₂@PPCF. (FIG. 3G) XRD patterns of MoS₂@PPCF and PPCF. (FIG. 3H) TGA of MoS₂@PPCF and PPCF (FIG. 3I).

FIGS. 4A-4E are electrochemical profiles of solid-state Li—In |SE|S-MOS₂@PPCF-SSE and Li—In |SSE|S-PPCF-SSE batteries. (FIG. 4A) Galvanostatic charge/discharge profiles of ASSLSBs using S—MoS₂@PPCF-SSE and S-PPCF-SSE as cathodes with sulfur loading of 2.9 mg cm⁻² and the current rate 0.27 mA cm⁻² (C/20). (FIG. 4B) CV profile of S—MoS₂@PPCF-SSE at a different scan rate of 0.1, 0.15, and 0.2 mV/s during the first three cycles in ASSLSB. (FIG. 4C) GITT profiles of S—MoS₂@PPCF-SSE and S-PPCF-SSE at the rate of C/20. (FIG. 4D) Performances at rates ranging from C/20 to 1 C. (FIG. 4E) Long-term cycling performance comparison of two solid-state cells at the rate of C/20 for the first three cycles and then adjusted to the rate of C/10 from the fourth cycle. All the cells are tested at room temperature.

FIGS. 5A-5F are deconvoluted high-resolution X-ray photoelectron spectroscopy (XPS) spectra of S—MoS₂@PPCF-SSE and S-PPCF-SSE electrode. (FIG. 5A) C 1s XPS spectra of MoS₂@PPCF (FIG. 5B) P 2P XPS spectra of MoS₂@PPCF (FIG. 5C) c1 2P XPS spectra of MoS₂@PPCF (FIG. 5D) C 1s XPS spectra of PPCF (FIG. 5E) p 2p XPS spectra of PPCF (FIG. 5F) Cl 2p XPS spectra of PPCF.

FIGS. 6A-61 are SEM images of S—MoS₂@PPCF-SSE cathode (FIGS. 6A-6C) before cycling, (FIGS. 6D-6F) fully charged to 3 V (versus Li/Li⁺) and (FIGS. 6G-61) fully discharge to 1 V (versus Li/Li⁺).

FIG. 7 is a comparison of specific capacity, sulfur content, and cycle number in different ASSLSBs.

FIG. 8 is an EDX spectrum of MoS₂@PPCF and atomic fraction table of corresponding elements.

FIG. 9 is the Nyquist plot of Li_{5.4}PS_{4.4}Cl_{1.6} solid-state electrolyte.

FIG. 10 is a thermogravimetric analysis (TGA) curve of S—MoS₂@PPCF-SSE, MoS₂@PPCF, sulfur, and Li_{5.4}PS_{4.4}Cl_{1.6}.

FIG. 11 is a Galvanostatic charge/discharge profiles of cells using MoS₂@PPCF-SSE and S—MoS₂@PPCF-SSE as cathodes.

FIG. 12 is the cyclic voltammetry (CV) profile of S-PPCF-SSE at different scan rate of 0.1 mV/s, 0.15 mV/s and 0.2 mV/s during first three cycles in ASSLSB.

FIG. 13 is the galvanostatic intermittent titration technique (GITT) charge/discharge curves corresponding polarization profile.

FIGS. 14A-14B are SEM images of S—MoS₂@PPCF-SSE after the rate performance test.

FIG. 15 is the Nyquist plot of S—MoS₂@PPCF-SSE full cell before and after cycling.

FIG. 16 is the Nyquist plot of the S-PPCF-SSE full cell before and after cycling.

### DETAILED DESCRIPTION

A description of example embodiments follows.

This study pioneered new idea that fabricating the high performance all-solid-state lithium-sulfur batteries (ASSLSBs) through developing surface functionalized and stabilized conductive carbon additives with metal sulfides.

An all-solid-state lithium-sulfur battery (ASSLSB) described herein includes a positive electrode, a negative electrode, and an inorganic solid electrolyte layer. This configuration may comprise additional components described herein.

A positive or negative electrode component of an ASSLSB may comprise carbon fibers. In one embodiment, the carbon fibers may be porous. In another embodiment, the carbon fibers may be stabilized on their surface by metal sulfides. The composition ratio of the carbon fibers to the metal sulfides are about 1:1 wt % to about 1:2 wt %. The inorganic solid electrolyte layer may comprise lithium. In another embodiment, example electrolytes include but are not limited to halides, sulfides, polymer electrolytes, composite polymer electrolytes, or any combination thereof. In another embodiment, the ratio of the solid-state electrolyte to stabilized carbon fibers are about 1:1 to about 2:1.

Potential electrodes that may be used in ASSLSBs when paired with embodiments include sulfur for cathodes and lithium metal, pre-lithiumated alloys such as Li—Zn, Li—Si, Li—SN, and Li—Al, Li₄Ti₅O₁₂, and LiFePO₄ for anodes.

Potential solid-state electrolytes that may be used in ASSLSBs when paired with embodiments include polymer electrolytes, composite polymer electrolytes, lithium lanthanum zirconium oxide (LLZO), lithium phosphorous oxynitride (LiPON), lithium thiophosphate Li₃PS₄, and in an example embodiment Li_{5.4}PS₄₄Cl_{1.6}.

In one embodiment, porous carbon host, which has been widely used in liquid cells, is proposed. However, the conventional porous carbon host used in liquid cells cannot be directly used in ASSLSBs because the nonmobile solid electrolytes cannot reach the sulfur confined in the pores buried deeply inside the carbon. An ideal porous carbon host should own a large specific surface area to provide sufficient sites for sulfur, but it is very critical that the pores should only locate at the outer surface of the carbon. Until now, though many works reported the application of porous carbon in ASSLSBs, none of them discussed the structure requirement of porous carbon. Here, for the first time, the ideal structure of the porous carbon is discussed, and polyacrylonitrile-derived porous carbon fibers (PPCF) with a unique core-shell structure where a layer of pores cover on dense core contributing to a high specific surface area is developed. As a result, the ASSLSBs employing this PPCF showed an outstanding electrochemical performance. Also, for the first time, a highly conductive carbon fiber decorated with vertically grown MoS₂ nanosheets was designed and applied in ASSLSBs. The chemical and electrochemical compatibility among MoS₂, sulfur, and sulfide SSE can greatly improve the stability of the cathode and therefore maintain pristine interfaces between the different compositions for stable ion and electron transport. The presence of electrical-conductive metallic 1T MoS₂ and its uniform distribution on carbon fiber without aggregation benefit the electron transfer between carbon and sulfur. Meanwhile, the unique layered structure of MoS₂ can be intercalated by a large amount of Li atoms and therefore facilitate both ionic and electronic conductivity. In consequence, the charge transfer and reaction kinetics were greatly enhanced, and the decomposition of SSEs was successfully relieved. As a result, the ASSLSB described herein delivered an ultrahigh initial discharge capacity of 1456 mAh g⁻¹ with ultrahigh initial coulombic efficiency and maintained high-capacity retention of 78% at 0.1 C after 220 cycles. The batteries also obtained remarkable rate performance of 1069 mAh g⁻¹ at 1 C.

To prepare an example embodiment of MoS₂ nanosheets and PPCF core-shell structures, the first step is to make the PPCF by electrospinning polyacrylonitrile (PAN) solution into nanofibers. The PAN nanofibers are then carbonized and activated, resulting in the formation of activated PAN nanofibers. The activated PAN nanofibers are then thermostreated and mixed with fine powders to from polyacrylonitrile derived porous carbon fibers (PPCF). The PPCF formed contains a unique core-shell structure where a layer of pores is covered on dense cores. A high specific surface area of about 1519 m2 g-1 was achieved, and the pores could effectively confine sulfur avoiding the formation of bulky sulfur. Pores were mainly distributed on the outer surface, rendering ion access to sulfur, which contributed to high sulfur utilization. A fibrous morphology further enabled efficient electron conduction paths through effective percolation. Alternatively, PPCF powders can be purchased commercially and used for the next step to mix with MoS₂ nanosheets to form the desired core-shell structures that may be used in all-solid-state lithium-sulfur batteries (ASSLSBs).

In another example embodiment, a hydrothermal process is used to make the core-shell structure comprising MoS₂ nanosheets and PPCF core-shell structures. A PPCF powder is dispersed in water and sonicated, making a PPCF dispersion. MoO₃, thioacetamide, and urea are then mixed into the PPCF dispersion, making MoS₂ and PPCF mixture. Through a sintering process involving heating the mixture, cooling the mixture, and then dialyzing the mixture, a resultant MoS₂@PPCF core-shell structure is formed. The MoS₂ is bound to the PPCF on the PPCF surface. The carbon fibers are interwoven together to form the core-shell structure with the MoS₂ nanosheets dispersed on the exterior surfaces of the carbon fibers.

In another embodiment, the core-shell structures comprise MoS₂ nanosheets that are hybrid 1T/2H MOS₂ nanosheets that are applied to the PPCF surface. Functionalization of MoS₂ to the PPCF surface increased conductivity. Another embodiment, the 1T/2H MOS₂@PPCF core-shell structure was applied in ASSLSBs. In another embodiment, a sulfide solid-state electrolyte (SSE) was used in the ASSLSBs comprising the 1T/2H MOS₂@PPCF core-shell structure. The MoS₂@PPCF core-shell structure stabilized the sulfide SSE and boosted the reaction kinetics of sulfur in the sulfide SSE.

In an example embodiment, hybrid 1T/2H MOS₂ nanosheets were uniformly grown on a high surface area and high conductive polyacrylonitrile-derived porous carbon fibers (PPCF) through a hydrothermal method described herein. The PPCF processes rich pores located mainly on the surface. The MoS₂@PPCF provided sufficient reaction sites for the conversion reaction of sulfur. In another embodiment, vertically grown MoS₂ nanosheets demonstrated superior chemical and electrochemical compatibility with carbon, SSE, and sulfur, relieving degradation of SSEs through reducing contact area of PPCF and SSEs. In another embodiment, a 2H MOS₂ nanosheet and a 1T MoS₂ nanosheet were grown onto PPCF making 2H MOS₂@PPCF and 1T MoS₂ @PPCF, wherein there is only the respective type of MoS₂ nanosheet grown onto PPCF without the other. In another embodiment, MoS₂@PPCF nanosheets have an average lateral size of about 50 nm to about 500 nm.

In an embodiment, the MoS₂@PPCF core-shell structure comprises a high surface area density of pores in the core of the polyacrylonitrile-derived porous carbon fibers. In another embodiment, the surface area density for the MoS₂@PPCF core-shell structure is about 1000 m2/g to about 2000 m2/g.

Another example embodiment is lithium (Li) ion intercalation with the MoS₂ nanosheets. The MoS₂ nanosheets possess high ion and electron conductivity, which effectively boosts the reaction kinetics of sulfur.

In an embodiment, ASSLBs have an initial discharge capacity of about 900 mAh/g to about 1600 mAh/g. In another embodiment, ASSLBs have a Coulombic efficiency of about 97% to about 100%. In another embodiment, ASSLBs have a capacity retention of about greater than or equal to 70% retention. In another embodiment, ASSLBs have a discharge capacity of about 900 mAh/g to about 1600 mAh/g. In an example embodiment, ASSLSBs were optimized to deliver an ultrahigh specific capacity of about 1456 mAh g⁻¹, high cycling stability of over about 220 cycles with high-capacity retention of about 78%, and a satisfactory rate capacity of about 1096 mAh g⁻¹ at 1 C was achieved. In another embodiment, an ASSLSB was tested comprising PPCF without the MoS₂ nanosheets, resulting in a lower initial discharge of about 1185 mAh g⁻¹ and a rate capacity decrease to about 220 mAh g⁻¹ at 1 C. In another embodiment, structure design criteria was determined for ASSLSBs, identifying that large specific surface area, pores primarily located at the surface of the carbon fibers, and easy to form percolation were ideal for the porous carbon of the core-shell structure used in the ASSLSBs.

In an embodiment, ASSLSBs were fabricated through a cold pressing method in a glove box, wherein a) a cathode was prepared with carbon fibers, sulfur, and a SSE, that is manually mixed, milled, sealed in a glass tube, and annealed b) the cathode is spread onto a side of a SSE powder pellet and an anode is spread onto the other side of the SSE powder pellet, thereby forming a cell c) a current collector was wrapped around the cell and cold pressed. In another embodiment, the carbon fibers are PPCF or MOS₂@PPCF. In another embodiment, the SSE is Li_{5.4}PS_{4.4}Cl_{1.6}. In another embodiment, the weight ratio of carbon fiber/sulfur/SSE is about 5/50/45, about 5/60/35, or about 10/40/50. In another embodiment, the cathode comprising MoS₂@PPCF and SSE in a ratio of about 1:5. In another embodiment, an anode comprises In—Li foil. In another embodiment, the current collector is Al, Cu, or a combination of Al and Cu foil.

In another embodiment, vapor grown carbon fibers (VGCF), a common carbon fiber with no surface pores, was used for an ASSLSB. Compared to an ASSLSB utilizing PPCF as a cathode, the PPCF cathode exhibited improved reaction kinetics with an overpotential reduction by 149 mV. A reduced overpotential explains faster kinetics and higher utilization of sulfur in sulfur-polyacrylonitrile derived porous carbon fiber-solid electrolyte (S-PPCF-SE). In the dQ/dV measurement, S-PPCF-SE demonstrated strong anodic/cathodic peaks with a high intensity of about 3156/4367 mAh g⁻¹ V-1, which are significantly higher than about 1010/1268 mAh g⁻¹ V-1 in S-VGCF-SE.

In some embodiments, a sulfide SSE that is used for the ASSLSBs comprising the MoS₂@PPCF core-shell structures is Li_{5.4}PS₄₄Cl_{1.6}. In another embodiment, the Li_{5.4}PS_{4.4}Cl_{1.6} sulfide SSE resulted in an ultrahigh ionic conductive of about 7.8 mS cm-1. A stabilization effect was observed on the sulfide SSE and a catalyst effect on the reaction kinetics were also observed on the sulfur. In another embodiment, Li_{5.4}PS_{4.4}Cl_{1.6} is prepared through a ball milling process and a subsequent annealing treatment using Li₂S, P₂S₅, and LiCl and sealed in a glass tube.

In other embodiments, ASSLSBs developed herein exhibited high-performance, high-energy density, high power density, and better safety as a result of using a metal sulfide externally attached to carbon fibers as electrodes and a sulfur SSE.

A possible use for ASSLSBs described herein includes use for energy storage. Solid-state lithium-ion batteries offer higher safety and increased energy density compared to traditional lithium-ion batteries, including the potential to store significantly more energy than traditional lithium-ion batteries. As a result of the potential to store more energy, other potential uses exist, including but not limited to grid station energy storage, electrical vehicles, and industrial batteries.

For the potential use of ASSLSBs described herein, grid station energy storage is possible. ASSLSBs not only have energy storage mentioned herein, but they also are expected to be more cost-effective than traditional lithium-ion batteries. ASSLSBs have the potential to store energy that has been generated from renewable sources such as solar and wind power. Further, due to ASSLSBs' ability to store more energy for longer periods of time and having a higher energy output than traditional lithium-ion batteries, ASSLSBs can overcome supplying electricity to consumers during peak periods and provide backup power to critical infrastructures.

Another potential use for ASSLSBs described herein includes the use of ASSLSBs in electric vehicles. Due to improved electrical input, such as improved lithium intercalation, ASSLSBs may be charged faster than traditional lithium-ion batteries, which is a current challenge electric vehicles face for more widespread adoption. ASSLSBs described herein also can store more energy compared to traditional lithium-ion batteries, allowing for increased distance to travel in an electric vehicle. Improved safety is also beneficial for electric vehicles as ASSLSBs are less vulnerable to fires and chemical leaks due to the solid-state electrolyte, which further benefits the longevity of the battery.

Further industrial applications include but are not limited to using ASSLSBs in portable electronic devices such as mobile phones, computers, tablets, and headphones. Using ASSLSBs described herein could improve battery life in electronic devices, allowing for less frequent charging, faster charging, devices less prone to overheating or possibly exploding, and enable more complex computation due to increased power output.

### Example 1. All-Solid-State Li—S Batteries Enhanced by Interface Stabilization and Reaction Kinetics Promotion Through Transition Metal Sulfides

Example 1 has been published in Adv. Mater. Interfaces 2022, 9, 2200539, which is incorporated herein by reference in its entirety.

Abstract. All-solid-state lithium-sulfur batteries (ASSLSBs) based on sulfide solid-state electrolytes (SSEs) provide prospectively high energy density and safety. However, the low conductivity and sluggish reaction kinetic of sulfur cathode limit its commercialization. The use of carbon additives can improve the electrical conductivity but accelerates the decomposition of SSEs. Herein, a highly conductive carbon fiber decorated with hybrid transition metal sulfides 1T/2H MOS₂ nanosheets was designed. The chemical and electrochemical compatibility among MoS₂, sulfur and sulfide SSE can greatly improve the stability of the cathode and therefore maintain pristine interfaces. The uniform distribution of electrical-conductive metallic 1T MoS₂ on carbon fiber benefits the electron transfer between carbon and sulfur. Meanwhile, the layered structure of MoS₂ can be intercalated by a large amount of Li ions to facilitate ionic and electronic conductivity. In consequence, the charge transfer and reaction kinetics were greatly enhanced, and the decomposition of SSEs was successfully relieved. As a result, the ASSLSB described herein delivered an ultrahigh initial discharge and charge capacity of 1456 mAh g⁻¹ and 1470 mAh g⁻¹ at 0.05 C individually with ultrahigh coulombic efficiency and maintained high-capacity retention of 78% after 220 cycles. The batteries also obtained a remarkable rate performance of 1069 mAh g⁻¹ at 1 C.

Introduction. Lithium-ion batteries (LiBs) play an important role in daily life, including portable electronics, electric vehicles, and large-scale grid storage.^{[1]} The US government sets a goal that 50% of new US vehicles should be electrically powered by 2030.^{[2]} However, commercial LiBs fabricated based on LiCoO₂ cathode, graphite anode, and organic liquid electrolyte show limited energy densities of 250 Wh kg⁻¹ and high safety risks.^{[3]} It is urgent to develop safe and high-energy-density batteries, and all-solid-state lithium-sulfur batteries (ASSLSBs) are a highly promising candidate. Lithium-sulfur (Li—S) battery owns an ultrahigh theoretical energy density of 2500 Wh kg⁻¹.^{[4]} However, Li—S batteries are generally facing the low coulombic efficiency and fast capacity decay caused by the severe polysulfide shuttle effects in liquid electrolyte. ASSLSBs thus come to priority due to their merits of: 1) eliminating polysulfide shuttle effects; 2) potentially higher energy density than traditional LiBs using liquid electrolytes; and 3) superior safety.

Among various solid-state electrolytes (SSEs), sulfide-based electrolytes are the top candidate for ASSLSBs due to their superior room-temperature ionic conductivities (>1 mS cm⁻¹) and high processibility. Furthermore, sulfide SSEs exhibit good chemical and electrochemical stability with the sulfur; thus, no need to fabricate extra costly and complicated interface engineering on the cathode surface. Unfortunately, although great efforts have been made, the performance of the ASSLSBs are still not comparable with Li—S batteries using liquid electrolyte.^{[5]} The challenges are: 1) low utilization of sulfur caused by low ion and electron conductions in the cathode because sulfur is both electronic and ionic insulating; 2) huge interfacial resistance due to the contact loss caused by the large volume change of sulfur during cycling; 3) sluggish reaction kinetics and higher thermodynamic barriers because of the one-step reaction from S& to Li₂S in all-solid-state reactions; and 4) sulfide SSEs behave narrow electrochemical stability window (ESW) of 1.7-2.3 V (versus Li/Li⁺), the addition of carbon can accelerate the decomposition of sulfide SSEs when the voltage exceeds the ESW, resulting in enlarged interface impedance, low capacity, low coulombic efficiency, and poor cycling stability. Porous carbon additives with high surface area have been employed to address the first two challenges through enhanced electron conduction, increased reaction sites, and accommodated volume expansion.^{[6,7]} However, the third and fourth challenges are still lack attention and investigation in ASSLSBs. It is important to employ advanced additives to boost the reaction kinetics of sulfur and relieve the decomposition of SSEs.

Transition metal sulfides have been reported that can significantly boost the reaction kinetics of the Li—S batteries in liquid electrolytes, and MoS₂ is one of the most investigated candidates.^{[8,9]} MoS₂ manifests in three different polymorphs which are defined as trigonal 1T, hexagonal 2H, and rhombohedral 3R. The unique chemical peculiarities of MoS₂ enable its prospective application in ASSLSBs. First, owing to the high ion conductivity obtained after lithiation, MoS₂ has been used as the interface stabilizing layer between the liquid electrolyte and Li metal anode.^{[10,11,12]} Second, 1T MoS₂ owns 105-106 times higher electrical conductivity than 2H MOS₂, which benefits the charge transfer. Third, MoS₂ can boost the conversion reaction kinetics of sulfur through a catalyst effect in Li—S batteries.^{[8,14]} Fourth, MoS₂ as a metal sulfide has excellent chemical and electrochemical stability with both sulfur and sulfide SSEs. However, compared to the application in Li—S batteries using liquid electrolytes,^{[11,15]} MoS₂ has rarely been investigated as advanced additives in ASSLSBs.

In this work, a functionalized conductive additive with high surface area, high conductivity, and core-shell carbon fibers decorated with hybrid 1T/2H MOS₂ nanosheets was designed and successfully applied in ASSLSBs. The high surface area polyacrylonitrile-derived porous carbon fibers (PPCF) has been investigated in previous work.^{[16]} Hybrid 1T/2H MOS₂ nanosheets were vertically grown on PPCF to fabricate MoS₂@PPCF through a hydrothermal method with water as the solvent. The MoS₂@PPCF was then utilized as the conductive additives in the sulfur cathode in ASSLSBs. The sulfide SSE, Li_{5.4}PS₄₄Cl_{1.6} was employed due to its ultrahigh ionic conductivity of 7.8 mS cm⁻¹. Its stabilization effect on sulfide SSE and the catalyst effect on the conversion reaction kinetics of sulfur were systematically investigated. As a result, the ASSLSBs employed MoS₂@PPCF delivered high performance.

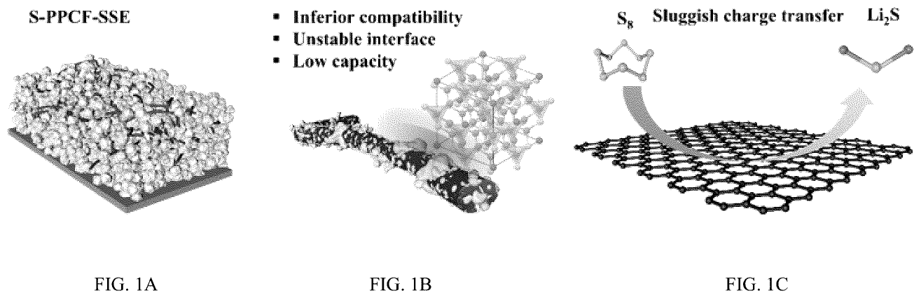

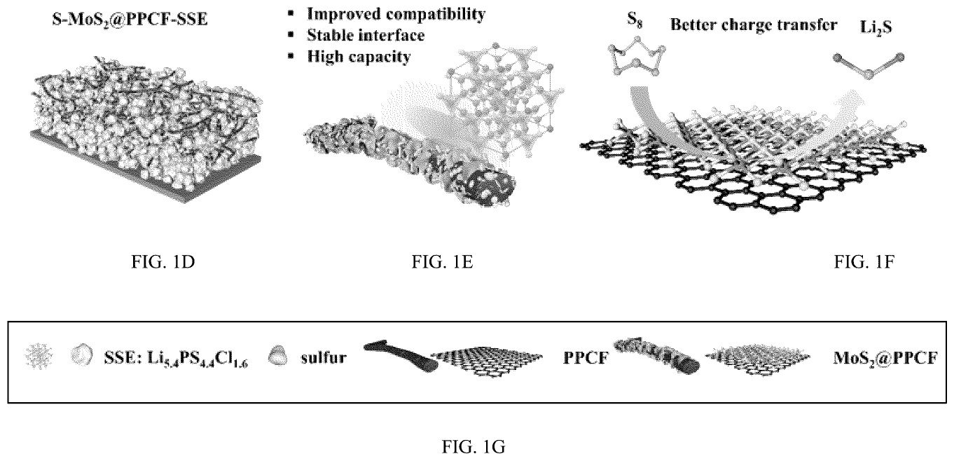

Results and Discussion. FIGS. 1A-1C illustrates the overview of this work. As displayed in FIG. 1A, the performance of bare PPCF was investigated in an ASSLSB using the mixture of sulfur, PPCF, and SSE (S-PPCF-SSE) as the cathode. Indium-lithium alloy was utilized as anode due to its excellent stability with sulfide SSE, Li_{5.4}PS_{4.4}Cl_{1.6}. Generally, sulfide SSE experiences a degradation if the working potential beyond its ESW. In the cathode, the sufficient contact of SSE with highly electronic conductive PPCF accelerates the SSE degradation, as illustrated in FIG. 1B. The degradation products own limited ionic conductivity resulting in gradually increased impedance and dramatically reduced capacity at high current rate. Meanwhile, as shown in FIG. 1C, the sulfur experiences a one-step conversion to Li₂S in ASSLSBs. The sluggish reaction kinetic negatively affects the rate performance and electrochemical reaction efficiency.

To solve the abovementioned challenges, MoS₂@PPCF, in which a hybrid 1T/2H MoS₂ nanosheets vertically grown on PPCF, was synthesized and mixed with sulfur and SSE (S—MoS₂@PPCF-SSE) to work as a cathode in the ASSLSB, as shown in FIG. 1D. MoS₂, as a metal sulfide, has excellent chemical and electrochemical stability with both sulfur and sulfide SSEs. The MoS₂ nanosheets cover on the surface of PPCF effectively reduce the direct contact area between SSE and PPCF, which can reduce the degradation of sulfide SSE (FIG. 1E). The stabilized carbon interface benefits the building of high ionic and considerable electronic conduction in the cathode and therefore improves the electrochemical performance. Moreover, MoS₂ is known as a good Li ion conductor whose 2D structure facilitates faster Li-ion diffusion.^{[17]} At the same time, due to the presence of conductive 1T phase MoS₂ and its uniform distribution on PPCF, the considerable electronic conductivity facilitates electron transfer. Meanwhile, the 2H phase MoS₂ can be transformed into the 1T phase after lithiation. With the intercalation of Li ions into the layer distance, both the ionic and electric conductivity of MoS₂ further increase. Therefore, as illustrated in FIGS. 1F, the MoS₂ on the PPCF is proposed to boost the conversion reaction kinetics of S₈ to Li₂S due to enhanced charge transfer. All these merits enable MoS₂@PPCF a highly promising conductive additive in the sulfur cathode to deliver better performance in ASSLSBs.

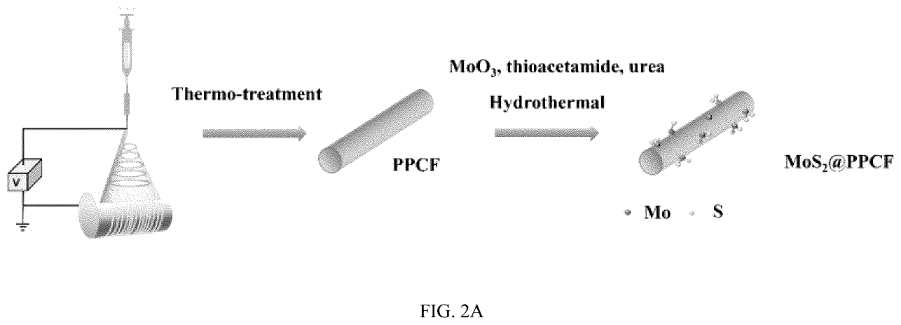

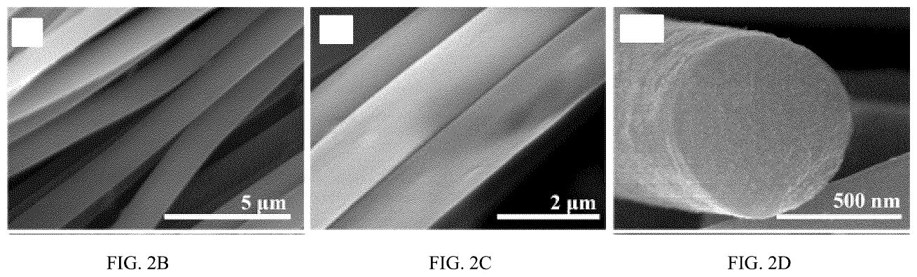

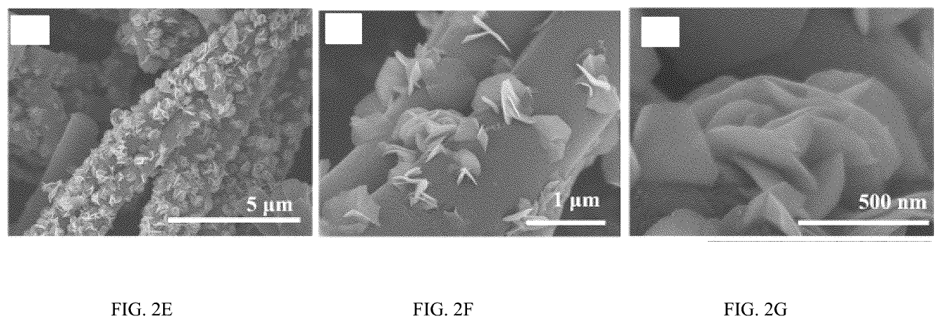

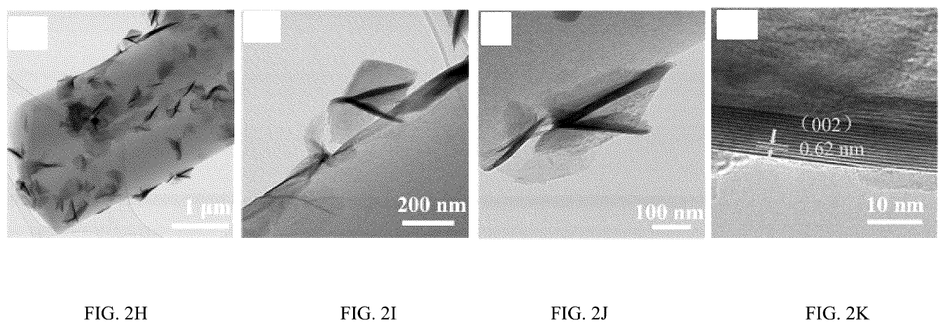

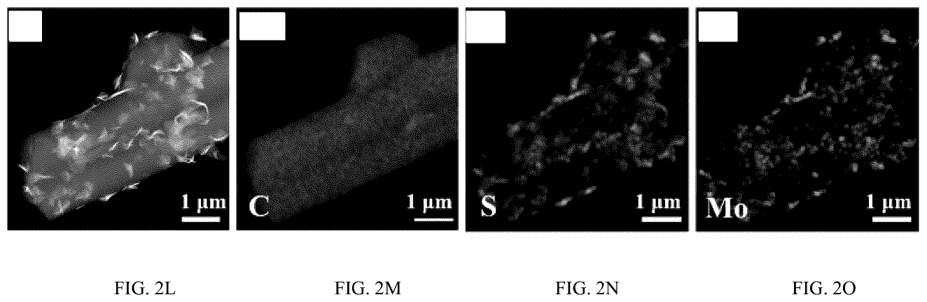

FIG. 2A shows the synthesis process of MoS₂@PPCF. The PPCF was fabricated with electrospinning followed by stabilization, carbonization, and activation processes, which was reported in our previous work.^{[16]} This PPCF possesses an ultrahigh Brunauer-Emmett-Teller (BET) specific surface area of 1519 m2 g⁻¹. In addition, PPCF owns a unique core-shell structure where a layer of pores is located at the fiber surface, which renders remarkable ion accessibility to sulfur, contributing to high sulfur utilization. FIGS. 2B-2D display the scanning electron microscopy (SEM) images of the PPCF at various magnifications. PPCF shows a 1D fibrous morphology, and the average diameter is around one micrometer. When further magnified in FIG. 2D, the PPCF shows cross-section morphology that a thin, porous layer covered on the dense fiber core. In comparison, FIGS. 2E-2G display the SEM images of MoS₂@PPCF with various magnifications. Flower-shaped MoS₂ nanosheets vertically grown and uniformly distributed on the surface of PPCF without aggregation. The MoS₂ owns nanosheets morphology with an average lateral size of ˜300 nm. In FIG. 2G, the MoS₂ nanosheets are anchored on the PPCF surface evenly with intimate contact benefiting the fast charge transfer. In contrast, MoS₂ without substrate easily aggregates and leads to poor contact between SSEs and sulfur.

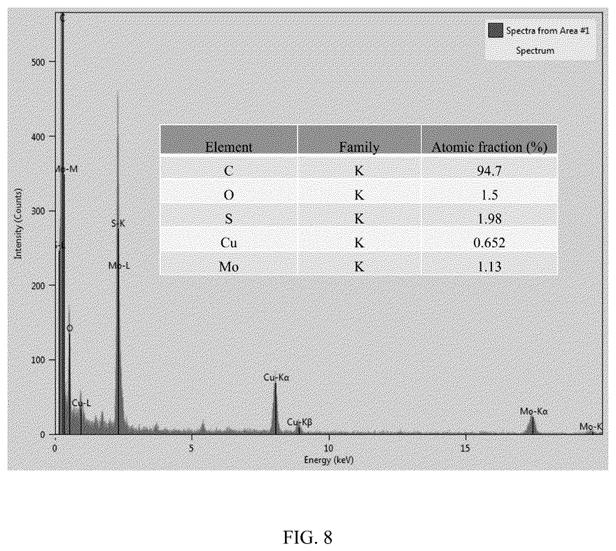

To further validate that the MoS₂ nanosheets are well distributed on PPCF without agglomeration, transmission electron microscopy (TEM) was performed. In FIG. 2H, the MoS₂ nanosheets are evenly located on the PPCF, which is consistent with the SEM results. FIGS. 2I-2J display the multilayer structure of MoS₂. MoS₂, as a typical layered transition metal sulfide, owns sandwiched structure which benefits the fast Li-ion diffusion. FIG. 2K shows the high magnification TEM image of the multilayered MoS₂. The lamellar structure is well defined and the interlayer distance is 0.62 nm which corresponds to the (002) lattice plane of MoS₂. The large interlayer distance of MoS₂, twice as much as the distance in graphite (0.34 nm in graphite^{[12]}), which can promote the Li-ion movement and therefore facilitate a fast Li-ion diffusion. FIGS. 2I-2O display the TEM image of MoS₂ @PPCF and corresponding energy dispersive X-ray (EDX) element mappings of C, S, and Mo. The energy-dispersive X-ray spectroscopy (EDX) spectrum of MoS₂@PPCF and atomic fraction table of corresponding elements are shown in FIG. 8. The ratio of S/Mo is around 2:1, which confirmed the successful synthesis of MoS₂ nanosheets on the carbon fiber.

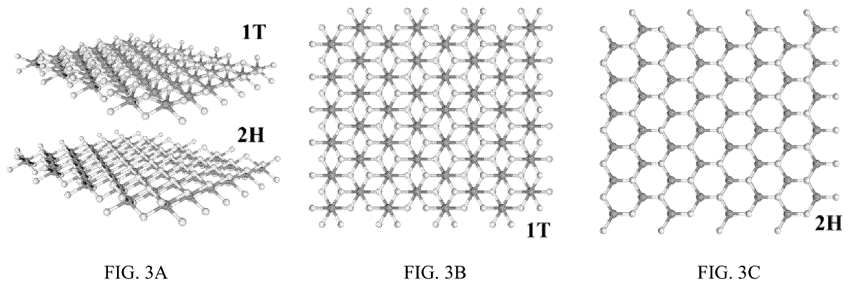

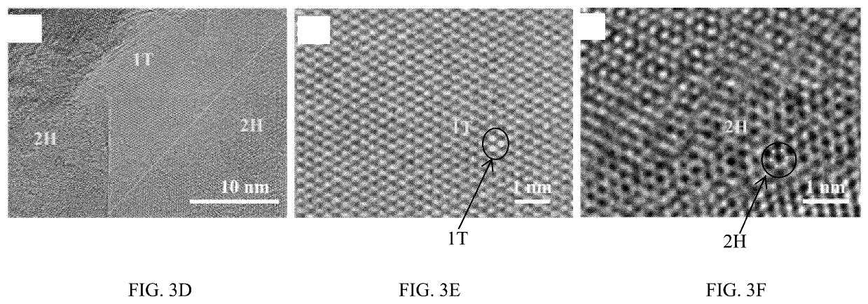

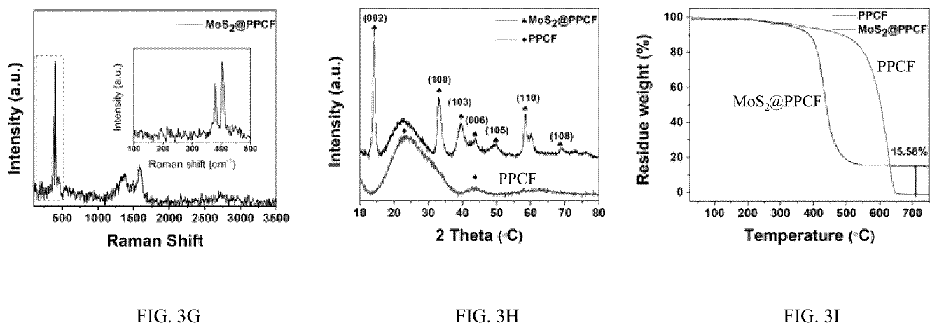

FIGS. 3A-3C compares the crystal structures of 2H phase and 1T phase MoS₂. 2H MoS₂ and 1T MoS₂ own the hexagonal and trigonal symmetry of the crystal structure, respectively.^{[22]} For 1T phase, the Mo atom is octahedrally coordinated to six neighboring sulfur atoms.^{[23]} In contrast, the Mo atom in 2H phase is prismatically coordinated by six S atoms. Due to different Mo and S atom coordination of octahedral structure with dense active sites, the 1T MoS₂ has 105 higher electrical conductivity than the 2H MOS^{[24]} High-resolution TEM was used to analyze the phases of MoS₂ in MoS₂@PPCF. As shown in FIG. 3D, the MoS₂ shows a hybrid structure of metallic 1T-MoS₂ phase with trigonal lattice geometry and 2H MOS₂ with common honeycomb lattice geometry. The 1T MoS₂ phase is not as stable as 2H MOS₂ explaining the hybrid phases in MOS₂@PPCF. In addition, a major part of basal planes still exhibits the periodic high-quality crystalline structure of 1T (FIG. 3E) and 2H (FIG. 3F) hybrid phases, while the partial or complete structural disorder appears at the grain boundaries due to their high surface energy.

Raman spectroscopy was utilized to study the chemical structure of MoS₂@PPCF, as shown in FIG. 3G. Two characteristics peaks located at 378 and 404 cm⁻¹ represent E¹_{2 g} (due to opposite vibration of two S atoms which respect to the Mo atom) and A_{1 g} (due to the vibration of only S atoms in opposite directions) models of 2H MOS₂, respectively. The signal of the 1T MoS₂ may be covered by the strong peak intensity of 2H MOS₂. Note that the ratio of 1T to 2H MoS₂ is difficult to control because the 1T phase is less stable than 2H phase and many conditions affect the content of 1T MoS₂ including the solvent, temperature, pressure, nucleation sites, and purity of the system. Moreover, there are two prominent peaks at 1378 and 1591 cm⁻¹ corresponding to the D and G bands of PPCF, respectively. The D and G bands are related to the disordered sp³ carbon structures and the sp² carbon stretching mode. The intensity ratio, I_{D}/I_{G}, of MoS₂@PPCF was 0.78 demonstrating the formation of a high proportion of graphitic carbon. FIG. 3H displays the XRD pattern of the MoS₂@PPCF. Compared with the pure PPCF, the MoS₂@PPCF owns obvious peaks at 14.4°, 32.2° and 58.5° ascribed to the (002), (100), and (110) diffraction peaks of MoS₂, respectively.^{[26]} The sharp peaks further provide evidence for the existence of highly crystalline MoS₂.

FIG. 3I displays the thermogravimetric analysis (TGA) profiles of MoS₂@PPCF and PPCF to determine the amount of MoS₂ in MoS₂@PPCF. TGA was conducted from room temperature to 800° C. at the rate of 10° C. min⁻¹ in the air atmosphere. The PPCF was totally burnt out, demonstrating high purity. In contrast, there are 15.58 wt. % remained in MoS₂@PPCF. The huge weight loss for MoS₂@PPCF, which was due to the oxidation of MoS₂ to MoO₃, occurred at approximately 300° C. and the loss of PPCF. According to the calculation, the amount of MoS₂ content in the MoS₂@PPCF composite is 17.33 wt. %.

$$2 {MoS}_{2} + 7 {O}_{2} \to 2 {MoO}_{3} + 4 {SO}_{2} \qquad Equation 1$$

The final product of TGA is MoO₃ and the according weight fraction is 15.58%. The molar mass of MoS₂ and MoO₃ is 160.07 g/mol and 143.94 g/mol individually. Therefore, the weight fraction of MoS₂ in MoS₂@PPCF composite is:

$$15 \text{.58} \% \times \frac{160.07}{143.94} = 17 \text{.33} \%$$

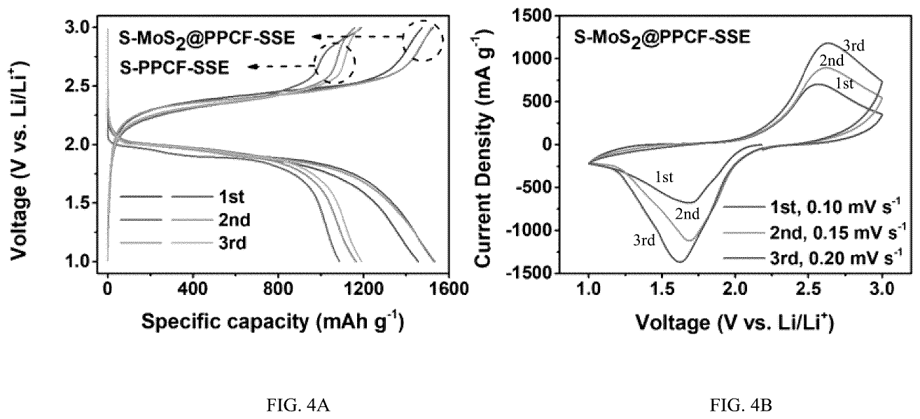

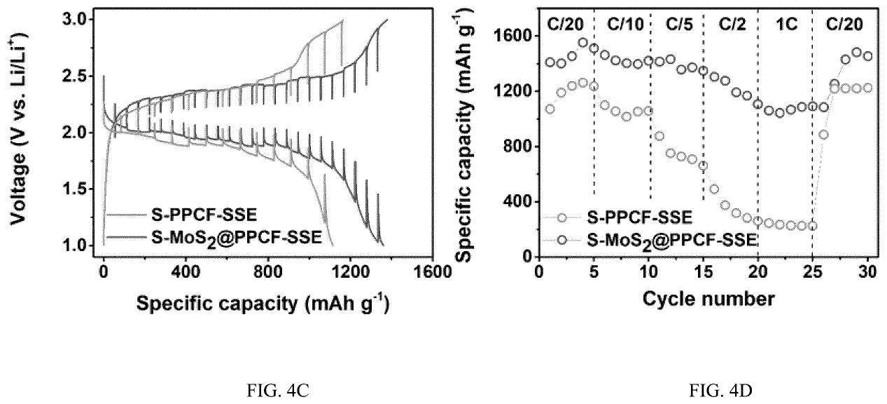

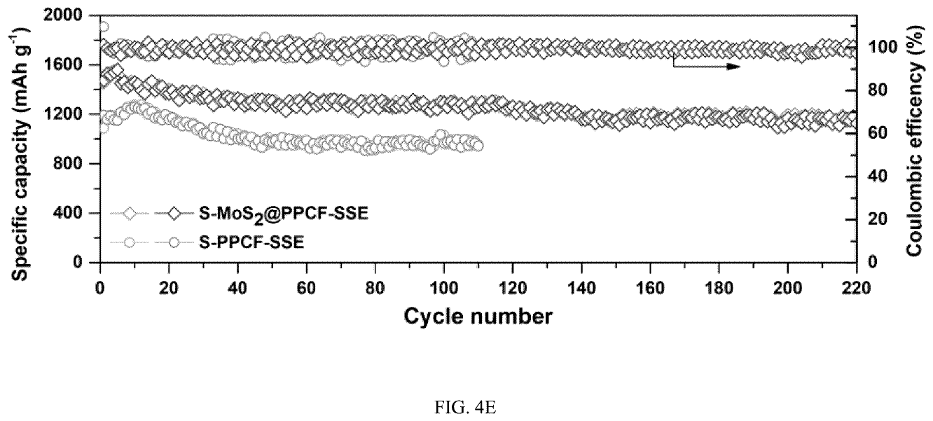

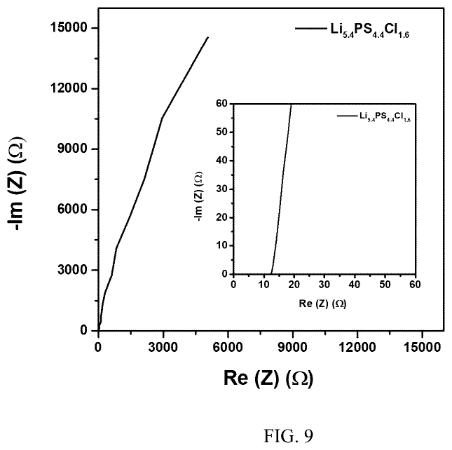

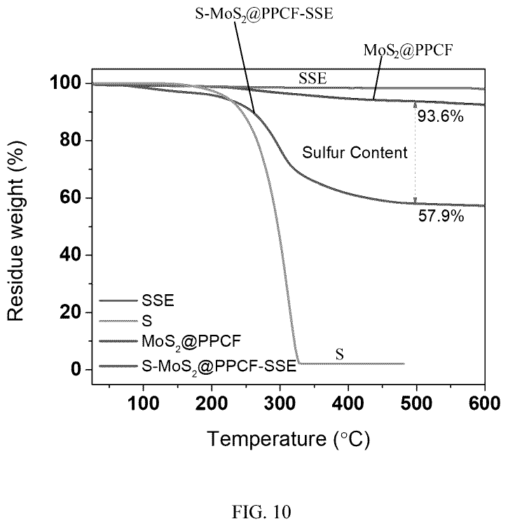

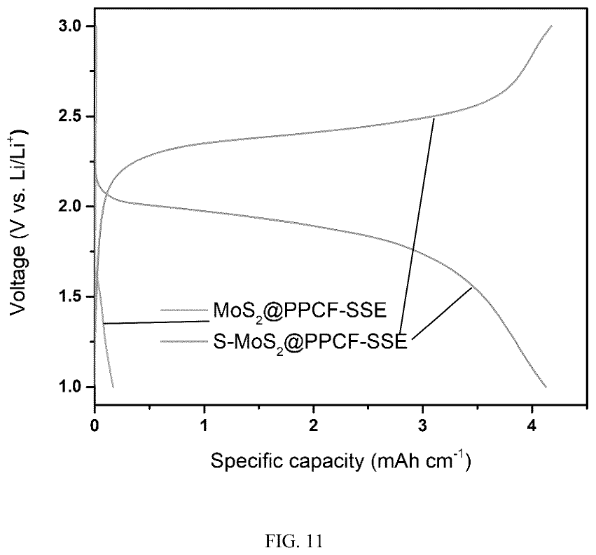

The sulfur was then mixed with the SSE and carbon additives, including MoS₂@PPCF and PPCF, to make the S—MoS₂@PPCF-SSE and S-PPCF-SSE cathodes through a ball milling and followed melting infiltration process. The SSE was Li_{5.6}PS_{4.4}Cl_{1.6} which shows a high room temperature ionic conductivity of 7.8 mS cm⁻¹ (FIG. 9). FIG. 10 displays TGA profiles of S—MoS₂@PPCF-SSE, MoS₂@PPCF, sulfur, and SSE to measure the exact ratio of sulfur in the cathode. TGA shows that the element of sulfur content of S—MoS₂@PPCF-SSE composites is 35.7%. FIG. 4A compares the galvanostatic charge/discharge profiles of ASSLSBs using the S—MoS₂@PPCF-SSE and S-PPCF-SSE as cathodes in the first three cycles at the current rate of C/20. All batteries were cycled at room temperature in the potential range of 0.4-2.4 V (versus In—Li), which corresponds to the voltage range of 1.0-3.0 V (vs. Li/Li⁺). S—MoS₂@PPCF-SSE delivers higher specific capacities and lower polarization than S-PPCF-SSE. The S—MoS₂@PPCF-SSE cathode delivered an ultrahigh discharge (lithiation) capacity of 1456 mAh g⁻¹ initially and a high charge (delithiation) capacity of 1470 mAh g⁻¹ with an ultrahigh initial coulombic efficiency. The extremely high initial coulombic efficiency is attributed to the stable materials and eliminated shuttle effects. Then the discharge capacity increased to 1531 mAh g⁻¹ in the following two cycles, which is due to the better utilization of sulfur. High coulombic efficiencies of ˜99.8% were obtained at 2^{nd} and 3^{rd} cycles, and the charge/discharge profiles were almost overlapping, which suggests the redox reaction owns highly reversibility and superior stability. Moreover, S—MoS₂@PPCF-SSE showed only one pair of charge/discharge plateaus related to the conversion between S₈ and Li₂S, which proved the direct one-step reaction (excluding the formation of lithium polysulfides) in ASSLSBs. In contrast, S-PPCF-SSE only delivered a charge (delithiation) capacity of 1190 mAh g⁻¹ and discharge (lithiation) capacity of 1086 mAh g⁻¹, which is much lower than that of S—MoS₂@PPCF-SSE. The initial coulombic efficiency is 109.6%, indicating an extra capacity contribution during charge. The decomposition of sulfide SSE contributes to the extra capacity during charge while accompanied by newborn impedance at the cathodes resulting a sluggish reaction kinetics. Besides the similar plateaus as S—MoS₂@PPCF-SSE, there is an extra plateau observed at 2.8 V (vs. Li/Li⁺) which coordinates with the SSE decomposition. Considering the narrow ESW of SSE, the SSE experienced a decomposition at high voltage.^{[27]} At the second and third cycles, the extra plateau disappears demonstrating the decomposition of SSE mainly occurs at the first cycle. The differences in these two cathodes demonstrate the MoS₂ layer on PPCF can relieve the decomposition of SSE and boost the utilization of sulfur. At the same time, a cell using MoS₂ as active material was tested to evaluate the capacity contribution of the MoS₂ in the S—MoS₂@PPCF-SSE cell. FIG. 11 compares the galvanostatic charge/discharge profiles of cells using the MoS₂@PPCF-SSE and S—MoS₂@PPCF-SSE as cathodes at the same current density of 0.27 mA cm⁻². The MoS₂@PPCF-SSE delivered a low discharge and charge capacities of 0.18 mAh cm-2 and 0.03 mAh cm⁻². The capacity contribution of MoS₂@PPCF-SSE is only 4.3% during discharge and negligible during charge. This result indicates that the MoS₂ contributes very low to the total electrode capacity.

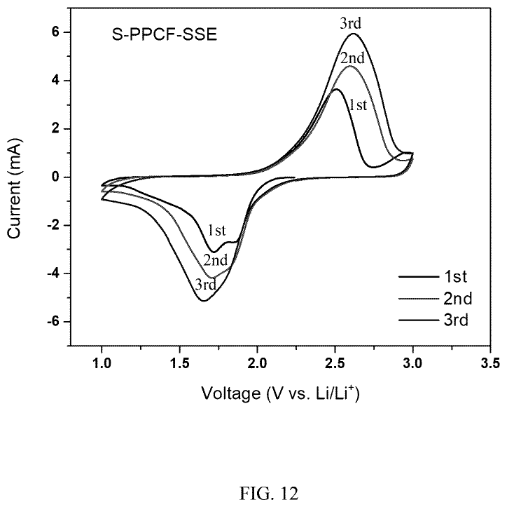

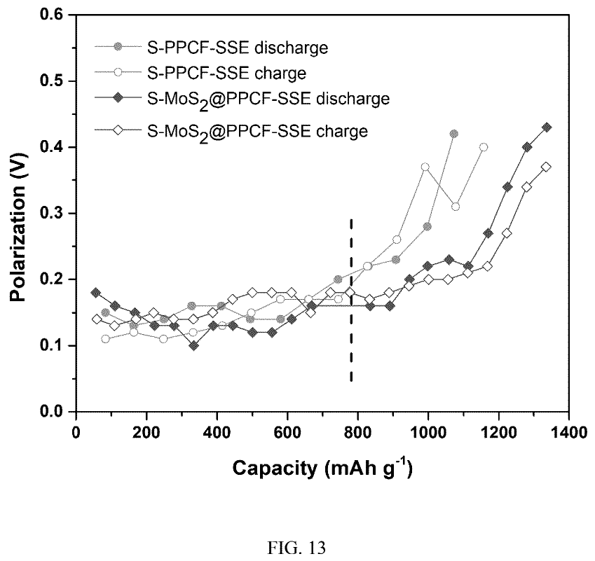

FIG. 4B shows cyclic voltammogram (CV) curves of S—MoS₂@PPCF-SSE in ASSLSBs in the potential range of 1.0-3.0 V (vs. Li/Li⁺) at various scan rates of 0.10, 0.15, and 0.20 mV s⁻¹ individually. In the first cathodic scan at 0.10 mV s⁻¹, one broad reduction peak at 1.7 V (vs. Li/Li⁺) was detected, contributing to the gradual reduction of sulfur: S+2Li⁺+2e⁻→Li₂S. Meanwhile, there was only one oxidation peak at 2.6 V (vs. Li/Li⁺), corresponding to the oxidation of Li₂S: Li₂S→2 Li⁺+S+2e⁻. In the following cycles, as the scan rates increase, both reduction and oxidation peaks shift a little due to higher polarization. In comparison, FIG. 12 presents the CV curves of S-PPCF-SSE cell at the same conditions. At 0.1 mV s⁻¹, there were two pairs of obvious oxidation and reduction peaks evidencing the SSE decomposition. As shown in FIG. 4C, the galvanostatic intermittent titration technique (GITT) was conducted to evaluate the diffusion and thermodynamic potential of electrochemical reactions.^{[28]} Both S-PPCF-SSE and S—MoS₂@PPCF-SSE cells exhibited a one-step reaction mechanism which are coincided well with CV curves. The corresponding polarization values of GITT charge/discharge profile is shown in FIG. 13. In both the oxidation/reduction processes, when the state of charge (SoC) is smaller than 46.6% (corresponding to specific capacity of 780 mAh g⁻¹), the difference of polarization of these two samples with and without MoS₂ coating is insignificant. However, the polarization difference becomes more obvious when the SoC larger than 46.6%. The polarization difference between these two cells can further prove the charge transfer and reaction kinetics were greatly enhanced by growing the MoS₂ nanosheets.

FIG. 4D compares the rate performances of S—MoS₂@PPCF-SSE and S-PPCF-SSE. The batteries were tested at current rates from 0.05 C to 1 C with five cycles at each rate. The S—MoS₂@PPCF-SSE shows significantly higher capacities than the S-PPCF-SSE, especially at high current rates. The S—MoS₂@PPCF-SSE delivers reversible discharge capacities of 1462, 1401, 1363, 1202, and 1059 mAh g⁻¹ at 0.05, 0.1, 0.2, 0.5, and 1 C, respectively. The capacity recovers to 1439 mAh g⁻¹ when the cell is recharged at 0.05 C, demonstrating the remarkable rate performance and stability. In comparison, the cell using S-PPCF-SSE cathode exhibits a lower capacity of 1232 mAh g⁻¹ at 0.05 C, and the capacity decreased to 220 mAh g⁻¹ at 1 C. The boosted rate performance in S—MoS₂@PPCF-SSE was highly attributed to the considerable ion and electron conductivity of MoS₂ during cycling and the excellent compatibility among sulfur, MoS₂, and SSE.

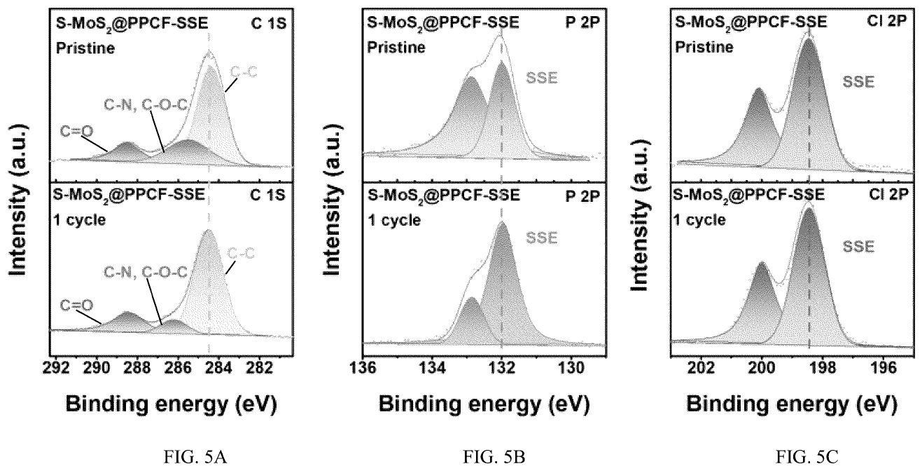

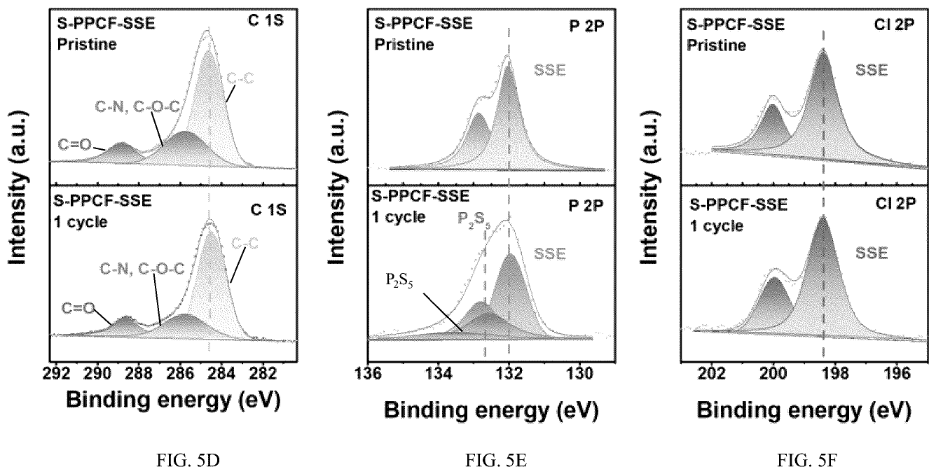

The long cycling performance of S—MoS₂@PPCF-SSE and S-PPCF-SSE at 0.1 C are compared in FIG. 5E. Before cycling, all cells were activated at 0.05 C for three cycles. After that, the S—MoS₂@PPCF-SSE achieved high discharge and capacities of 1550 and 1540 mAh g⁻¹, and the capacity maintained stable for 220 cycles with capacity retention of 78%. In contrast, sulfur-polyacrylonitrile derived porous carbon fiber-solid electrolyte (S-PPCF-SE) delivers discharge and charge capacities of 1185 and 1153 mAh g⁻¹, respectively. Meanwhile, the capacity of S-PPCF-SSE quickly decreased to 966 mAh g⁻¹ in 50 cycles and then keep stable for 110 cycles. The capacity loss may be attributed to the gradually increased impedance caused by the decomposition of SSE. After a stable interface is formed, the capacity is maintained stable.

X-ray photoelectron spectra (XPS) were used to analyze the chemical structure and stability of cathodes in ASSLSBs. FIGS. 5A-5C compare the high-resolution XPS spectra of C, P, and Cl elements in S—MoS₂@PPCF-SSE in pristine and after one cycle in ASSLSB. In FIG. 5A, the main component peak is located at 284.5 eV, corresponding to the C═C bond (sp²). The component peak at 285.9 eV is assigned to the C—N/C—O—C bond peak. The peak at higher bonding energy around 288.8 eV is indexed to the C—O bond peak. No obvious change for the C 1s peak was observed before and after one cycle, evidencing no chemical change. The evolution of high-resolution XPS P 2p spectra is depicted in FIG. 5B. The P 2p signals are split into two components due to spin-orbit coupling, which shows a unique 2p_{3/2}-2p_{1/2} doublet. The P 2p spectrum shows the main doublet with the P 2p_{3/2} component located at 132 eV. Investigation of P 2p spectra scan indicated that signature of argyrodite, and it doesn't show the obvious difference between the pristine cathode and that after one cycle.^{[30]} FIG. 5C displays the Cl 2p spectra and main component peak located at 198.4 eV (Cl 2p_{3/2}), which presents the Cl-ions. No obvious change occurs for the Cl 2p peak before and after one cycle.^{[31]} Therefore, no chemical change of phosphorus and chlorine chemical is detected, which indicates the stability of SE.

In comparison, XPS was also conducted for S-PPCF-SSE in pristine and after one cycle. The component peaks located at 284.5, 285.9, and 288.9 eV of C 1s spectrum can be indexed to C—C, C—N/C—O—C, and C—O, respectively, which are depicted in FIG. 5D. No additional component formed at the pristine state during the investigation of the P 2p spectra scan (FIG. 5E). However, upon the full charge of the In—Li|SSE|S-PPCF-SSE cell to 3 V (vs. Li/Li), an additional component appeared at 132.8 eV in agreement with the P₂S₅ peak from SSE decomposition. These findings agree with the existing literature studies on the oxidation of sulfide SSE.^{[31,32]} Different from the P 2p spectrum, the decomposition product LiCl of argyrodite cannot be detected in the Cl 2p spectrum because its Cl 2p bonding energy is almost the same as SSE.

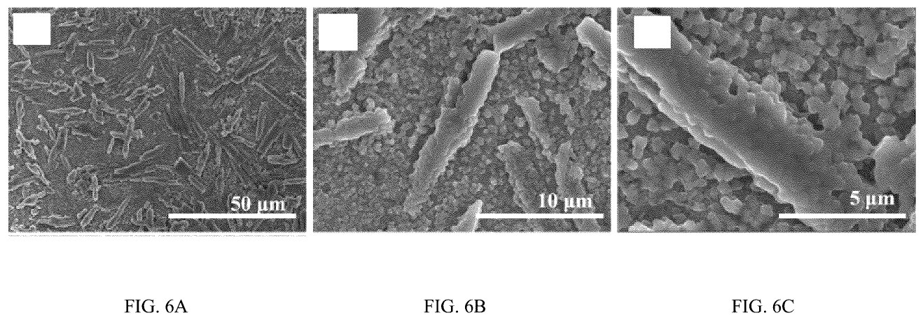

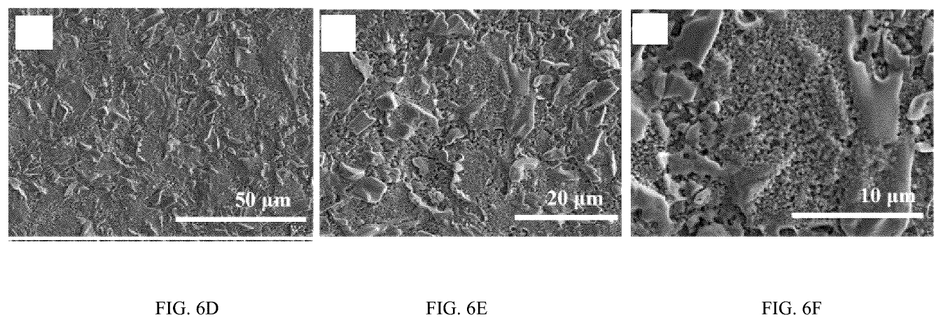

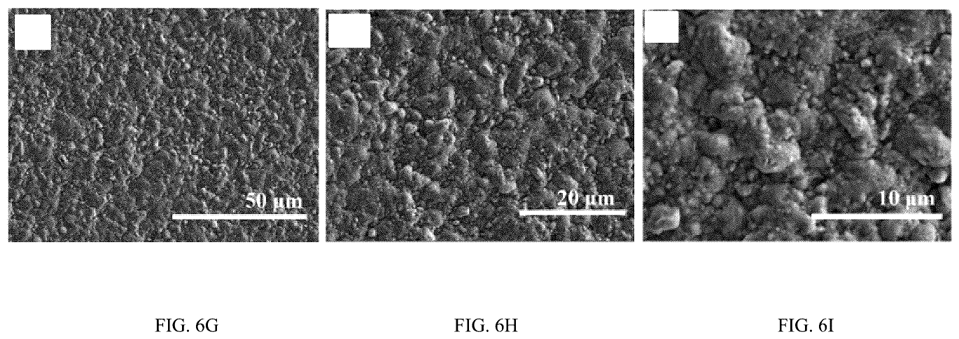

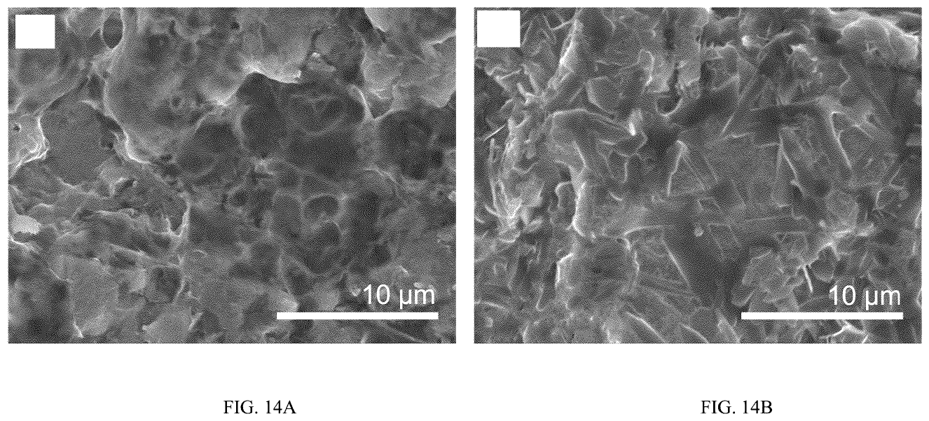

The morphology evolution of the S—MoS₂@PPCF-SSE before and after cycling was investigated in FIG. 6. The disperse of the MoS₂@PPCF, sulfur and Li_{5.4}PS4.4Cl_{1.6} is very uniform in the pristine state before cycling, as shown in FIGS. 6A-6C. The MoS₂@PPCF was covered by the SSE and sulfur, therefore MoS₂ nanosheets cannot be observed clearly, which further proved the intimate contact. Upon the further fully charge of the cell to 3 V (versus Li/Li), the electrode looks looser than the fully discharge state due to the delithiation of Li₂S. (FIGS. 6D-6F). However, upon fully discharge of the cell to 1 V (vs. Li/Li), the volume increases significantly due to the lithiation and conversion of sulfur to Li₂S, as shown in FIGS. 6G-6I. Therefore, the electrode looks denser compared with the pristine one. Although the volume change exists in the cathode during the lithiation and delithiation, there are no cracks generated and no structural corruption demonstrating the excellent structural stability. FIG. 14 shows the SEM images of the S—MoS₂@PPCF-SSE electrode after the rate test. The dense electrode maintains good integrity evidencing the excellent stability.

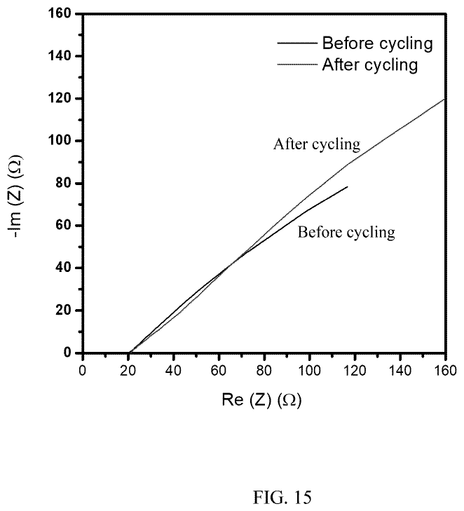

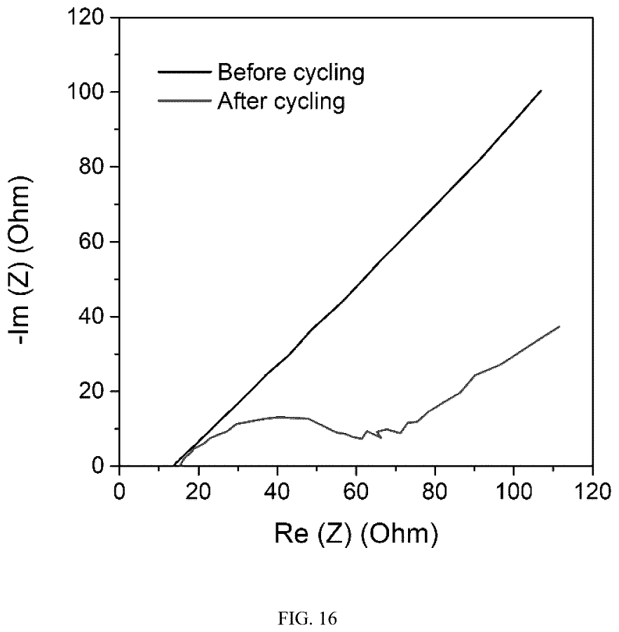

The Nyquist plot of a S—MoS₂@PPCF-SSE cell that was fully charged was tested before and after cycling are compared in FIG. 15. No huge difference is observed which can further prove the excellent stability. In contrast, there is an obvious impedance increase of 45Ω in S-PPCF-SSE cell that was fully charged after cycling due to the decomposition of SSE, as shown in FIG. 16

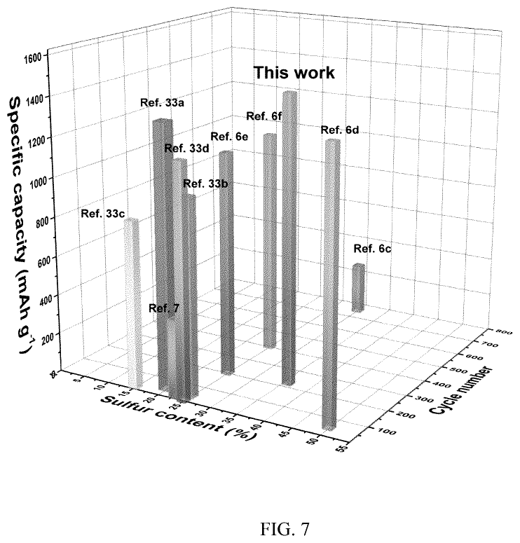

S—MoS₂@PPCF-SSE delivered an outstanding performance in ASSLSBs. FIG. 7 compares the sulfur content, cycling life, and capacity of S—MoS₂@PPCF-SSE with other reported ASSLSBs.^{[7,33]} Detailed information is provided in Table 1. The cell described herein delivered the highest specific capacity of 1456 mAh g⁻¹, high sulfur loading of 36%, and the long cycling life of 220 cycles. The outstanding performance was mainly attributed to the utilization of the surface modified carbon additives, MoS₂@PPCF. Firstly, the PPCF owns a high conductivity and high surface area which provides rich reaction sites for sulfur, therefore, resulting in the high mass loading of sulfur. Secondly, the highly ionic and electronic conductive MoS₂ layer benefits the charge transfer and boosts the conversion reaction kinetics of the sulfur, accompanied by enhanced sulfur utilization and high specific capacity. From the TGA result, MoS₂ weight fraction of ˜17.33% was calculated. With this amount of dosage, if the MoS₂ is electrically and ionically insulating, the electrochemical performance will be extremely low due to the isolation of electrons and ions. The much-improved electrochemical performance after MoS₂ coating in this work proved that MoS₂ has considerable electrical and ionic conductivity after lithiation. Thirdly, the surface MoS₂ exhibits excellent chemical and electrochemical compatibility with sulfur and sulfide SSE since all of them belong to sulfide-based materials. The surface MoS₂ nanosheets reduced the contact area between PPCF and SSE which relieves the decomposition of sulfide SSE and contributes to a stable cycling behavior. All these merits contribute to the outstanding performance of this work presented in FIG. 7.

Conclusion. In summary, an advanced carbon fiber decorated with vertically grown 1T/2H MOS₂ nanosheets was designed to address the faced challenges in all-solid-state lithium-sulfur batteries (ASSLSBs), including the interface instability in sulfide solid-state electrolyte (SSE), the poor electronic and ionic conductivity, and the sluggish reaction kinetics. MoS₂, as metal sulfide, owns excellent chemical and electrochemical stability with both sulfur and sulfide SSEs. Therefore, the MoS₂ nanosheets grown on carbon fiber effectively prevent the severe decomposition of sulfide SSE under high voltage. The presence of electrically conductive 1T phase MoS₂ and its uniform distribution on carbon fiber without aggregation improve electron transfer efficiency. The unique layered structure of MoS₂ can be intercalated by a large amount of Li ions and therefore facilitate ionic conductivity. As a result, the cell which owns high ion and electron transport network delivered an ultrahigh initial discharge capacity of 1456 mAh g⁻¹, ultrahigh coulombic efficiency of ˜100%, high cycling stability with capacity retention of 78% over 220 cycles at 0.1 C, and outstanding rate performance of discharge capacity 1096 mAh g⁻¹ at 1 C. The stable interface without side reactions and eliminated shuttle effects contribute to the extremely high initial coulombic efficiency. In contrast, the carbon fibers without MoS₂ obtained the lower initial discharge of 1185 mAh g⁻¹ and the much poorer rate capacity of 220 mAh g⁻¹ at 1 C due to more inferior interface stability and limited ionic conductivity at interface from degradation products. This study revealed the significance of the interface stabilization and functionalization of carbon additives for high performance all-solid-state lithium-sulfur batteries.

### Experimental Section

Li_{5.4}PS_{4.4}Cl_{1.6} Preparation. The preparation of Li_{5.4}PS₄₄Cl_{1.6} included a ball milling process and a subsequent annealing treatment. Briefly, Li₂S (Sigma-Aldrich, 99.98%), P₂S₅ (Sigma-Aldrich, 99%), and LiCl (Sigma-Aldrich, 99%) were mixed through ball milling for 10 Hours (h) at 500 rpm in a vacuum atmosphere. Then the mixture electrolyte precursor was sealed in a glass tube and annealed at 510° C. for 2 h in the tube furnace.

### Preparation of PPCF.

Electrospinning. The synthesis of PPCF was based on previous work. Generally, the polyacrylonitrile (PAN) powder (Sigma-Aldrich, USA) possessing a molecular weight of 150 000 (Mw), and then they were dissolved in N,N-dimethylformamide (DMF) (Fisher Scientific, 99.9%) to obtain the 15 weight percent (wt. %) solution. The mixture was stirred for 24 h at room temperature to become a homogeneous solution. The distance between the aluminum (Al) foil collector and syringe needle was 20 cm and the feed rate of the syringe pump was 2.0 mL/hour. Then the high voltage of 15 kV was applied.

Thermotreatment of PAN precursor nanofibers and activation. The electrospun PAN precursor nanofibers were stabilized, carbonized, and activated to obtain the high-quality PPCF. The stabilization of as-electrospun nanofibers was carried out in a muffle furnace (GSL 1200X, MTI Corporation, Richmond, CA). The heating was in the air from room temperature to 250° C. with a heating rate of 1° C. min⁻¹ and held at 250° C. for one hour. The carbonization was conducted in a tubular furnace (GSL 1600X, MTI Corporation, Richmond, CA) during the Nitrogen (N₂) atmosphere. Then the stabilized PAN nanofibers were carbonized from room temperature to 1000° C. with a heating rate of 5° C. min⁻¹. The samples were held at 1,000° C. was for one hour in flowing N₂, followed by automatically cooling down to room temperature. To obtain the activated carbon nanofibers, solid potassium hydroxide (KOH) was used to fabricate a porous structure. Carbon nanofibers were manually mixed with KOH fine powders with a weight ratio of 1:3. Then the mixture powders were activated to 1,000° C. for one hour in flowing N₂. After cooling to room temperature, the samples were purified against deionized water by multiple washing steps until the pH value of the water was stable. The dialyzed activated carbon nanofibers were then lyophilized and the evaporated PPCF was kept in a dry oven for future use.

Preparation of hybrid 1T/2H MOS₂@PPCF. Hybrid 1T/2H MOS₂@PPCF was prepared by a hydrothermal method. In a typical synthesis process, 60 mg PPCF was dispersed in 15 ml deionized water using sonicate bath for two hours. MoO₃ (18 mg, Fisher Scientific, USA), thioacetamide (21 mg, Sigma-Aldrich, USA), and urea (150 mg, Sigma-Aldrich, USA) were added in the as-prepared PPCF dispersion and stirring continued for one hour. Then the sample was transferred to a 25 ml Teflon-sealed autoclave. The autoclave was kept in a furnace for 16 h at 200° C. After cooling to room temperature, the hybrid 1T/2H MOS₂@PPCF were taken out and washed with ethanol three times. Then the samples were dialyzed against deionized water multiple times. The dialyzed MoS₂@PPCF was then lyophilized and evaporated at 60° C.

### Electrochemical Characterization of ASSLSBs.

Fabrication of All-Solid-State Li Sulfur Battery. ASSLSBs were fabricated by cold pressing method in the glovebox. For the cathode preparation, PPCF with/without MoS₂, sulfur and Li_{5.4}PS₄₄Cl_{1.6} were manually mixed as the weight ratio of 10/40/50 in a stainless-steel jar by mechanically milling for 10 h at a rotating speed of 400 rpm. Then the mixture was sealed in a glass tube and annealed from room temperature to 155° C. with the heating rate of 1° C. min⁻¹ in the tube furnace. Then the mixture was held at 155° C. for 12 hours and cooled down to room temperature with the ramp of 1° C. min⁻¹. Then mix the pre-prepared mixture with 3 wt. % CNT and ball milling at 400 rpm speed for 2 h.

ASSLSBs were assembled as follows. Two hundred milligrams of Li_{5.4}PS₄₄Cl_{1.6} powder was first put into a PEEK cylinder and pressed into a pellet with a diameter of 12.7 mm under 300 MPa. Then 10 mg of the as-prepared composite cathode was carefully spread onto the side of the Li_{5.4}PS₄₄Cl_{1.6} electrolyte pellet. A piece of In (80 mg)-Li (2 mg) foil was utilized as the anode and pressed on the other side of the Li_{5.4}PS₄₄Cl_{1.6} electrolyte pellet. Finally, Al and Cu foils were selected as the current collector, and the entire cell was cold-pressed under 300 MPa for 20 min. The MoS₂@PPCF-SSE cell was assembled using abovementioned method except the cathode compositing of MoS₂@PPCF and SSE in a ratio of 1:5.

Rate and cycling performance. The rate and cycling measurements were performed with a protocol that cell first discharged to 1.0 V (vs. Li/Li⁺) at constant current, and then charged to 3.0 V (vs. Li/Li⁺) at constant current. The current was based on the capacity and mass of cathode active material. The rate performance was conducted C/20, C/10, C/5, C/2, 1 C for five cycles, respectively. For the long cycling performance, all cells were activated for the first three cycles at C/20, then keep cycling at C/10.

GITT measurement. All the cells were first discharged with a constant current rate of C/20 applied for 1 h and rested for 4 h until the voltage reached 1.0 V (vs. Li/Li⁺). And then the cells were charged with same current rate applied for 1 h and rested for 4 h until the voltage reached 3.0 V (vs. Li/Li⁺).

Materials Characterization. The X-ray diffraction (XRD) was conducted on PANalytical/Philips X'Pert Pro with Cu Kα radiation. Raman spectra were measured on a Thermo Scientific DXR with 532 nm laser excitation. The scanning electron microscopy (SEM) and energy-dispersive X-ray spectroscopy (EDS) mapping were characterized by SEM (JEPL JSM 7000F). Sulfur loading in the composites cathode was determined from the thermal gravimetric analysis (TGA) measurement (TA Q50, Inc) at the N₂ atmosphere with the heating rate of 10° C. min⁻¹. TEM and EDS mapping images were tested on the Cs-corrected TEM/STEM-FEI Titan Themis 300. The chemical structure comparisons of the samples were analyzed by X-ray photoelectron spectroscopy (XPS, Thermo Scientific K-Alpha).

TABLE 1
Comparison of specific capacity, sulfur content
and cycle number during different ASSLSB

| | | | Discharge | | | | | |
|---|---|---|---|---|---|---|---|---|
| | | | capacity | | | | | |
| Cathode | | | (mAh/g) | | Rate | Temp. | Cycle | |
| (wt %) | SSE | Anode | Initial | Final | (C) | (° C.) | No. | Ref. |
| S—MoS₂@PPCF- | Li_{5.4}PS_{4.4}Cl_{1.6} | Li—In | 1456 | 1158 | 0.1 | 25° C. | 220 | This |
| SSE | | | | | | | | work |
| (36-14-50) | | | | | | | | |
| S-Super P-SSE | Li₆PS₅Br | Li—In | 1335 | 1080 | 0.1 | 25° C. | 50 | 33a |
| (20-10-70) | | | | | | | | |
| S-AB-SSE | Li_{3.25}Ge_{0.25}P_{0.75} | Li—In | 1000 | 810 | 0.05 | 25° C. | 40 | 33b |
| (25-25-50) | S4 | | | | | | | |
| S—FeS₂—C-SSE | LiI/Li₃PS₄ | Li | 850 | 1200 | 0.05 | 20° C. | 20 | 33c |
| (15-15-20-50) | | | | | | | | |
| S-MCMB-SSE- | L₂S—P₂S₅ | Li | 396 | 400 | 0.05 | 80° C. | 20 | 7 |
| Super P | | | | | | | | |
| (23-23-45-9) | | | | | | | | |
| Sulfur-SSE- | LiCe(BH₄)₃Cl | Li—In | 1186 | 510 | 0.01 | 45° C. | 9 | 33d |
| KB600 | | | | | | | | |
| (25-50-25) | | | | | | | | |
| rGO@S-SSE- | Li₁₀GeP₂S₁₂ and | Li | 270 | 50 | 1 | 25° C. | 750 | 6c |
| AB | 75% Li₂S—24% | | | | | | | |
| (30-50-20) | P₂S₅—1% P₂O₅ | | | | | | | |
| S-SSE-KB | Li_{1.5}PS_{3.3} | Li—In | 1350 | 1250 | 0.16 | 25° C. | 50 | 6d |
| (50:40:10) | | | | | | | | |
| S-CNT-SSE | Li₁₀GeP₂S₁₂ | Li—In | 1139 | 999 | 0.1 | 25° C. | 200 | 6e |
| (25:25:50) | | | | | | | | |
| S-CNT-SSE | 78Li₂S—22P₂S₅ | Li—In | 1141 | 1141 | 0.1 | 25° C. | 400 | 6f |
| (25-15-60) | | | | | | | | |

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and materials similar or equivalent to those described herein may be used in the practice for testing of the present disclosure, exemplary materials and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents) also provide as embodiments those independently described in terms of “consisting of” and “consisting essentially of.”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, ±4, ±3, ±2 or ±1% of a given value. It is to be understood that the term “about” can precede any particular value specified herein, except for particular values used in the Examples. For example, “about” can mean a standard of deviation of ±0.1 μm, ±0.2 μm, ±0.3 μm, ±0.4 μm, ±0.5 μm, ±0.6 μm, ±0.7 μm, ±0.8 μm, ±0.9 μm, ±1 μm for the thickness of the polyacrylonitrile-derived porous carbon fibers.

All percents are intended to be weight percent unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

As used herein, the term “nanosheet” is a two-dimensional structure with a thickness in a scale ranging from about 0.1 nm to about 1000 nm. An example embodiment is a MoS₂ nanosheet that is coated onto polyacrylonitrile-derived porous carbon fibers (PPCF).

“MoS₂@PPCF” describes a MoS₂ nanosheet that is grown onto an external surface of polyacrylonitrile-derived porous carbon fibers.

As used herein, the term “1T MoS₂ phase” describes a Mo atom that is octahedrally coordinated to six neighboring sulfur atoms. As used herein, the term “2H MOS₂ phase” describes the Mo atom is coordinated prismatically by six neighboring sulfur atoms. The 1T MoS₂ phases ultimately has a higher electrical conductivity than 2H MOS₂ as the octahedral structure contains more dense active sites.

As used herein, the term “intercalation” describes a reversible inclusion or insertion of ions into compounds with layered structures. In an example embodiment, lithium-ions intercalate during a charging and a discharging process. The discharging process has the lithium ions moving from a negative electrode to a positive electrode through an electrolyte. The charging process has the lithium ions moving from the positive electrode to the negative electrode through an electrolyte. This process minimizes volume change and mechanical strain on a battery during repeated insertion and extraction of ions.

As used herein, the term “surface area density” describes a two-dimensional object that has a mass per unit area. In an example embodiment, surface area density relates to an attribute of all-solid-state lithium-sulfur batteries, wherein the surface area density correlates with faster ion transport and higher power density. Solid electrolyte interface affects the stability of the battery and the overall performance of the battery; therefore, a larger surface area density is more beneficial. “Surface area density” may also be referred to as areal density, superficial density, areic density, mass thickness, column density, or density thickness. “Surface area density” is measured in kilogram per square meter (kg m-2). The surface area density can be determined using Brunauer-Emmett-Teller (BET) theory, which applies to systems of multilayer adsorption that utilizes a probing gas (adsorbate) that does not chemically react with an adsorptive (material to which the gas attaches to) to quantify the specific surface area.

As used herein, “polymer electrolyte” refers to a polymer matrix capable of ion conduction, aiding in the movement of charge between an anode and a cathode in a battery. As used herein “composite polymer electrolyte” refers to a “polymer electrolyte” with incorporation of inorganic fillers in the polymer matrix. The fillers are chemically inert but have a high dielectric constant, which can improve ion conductivity by inhibiting the formation of ion pairs withing the polymer matrix. Some common “polymer electrolytes” include, but are not limited to poly(ethylene oxide), poly(vinyl alcohol), poly(methyl methacrylate), poly(caprolactone), poly(chitosan), poly(vinyl pyrrolidone), poly(vinyl chloride), poly(vinylidene fluoride), or poly(imide). Some common examples of inorganic fillers that may be used in “composite polymer electrolytes” include, but are not limited to TiO₂, Al₂O₃, SiO₂, ZiO₂, or a combination thereof.

As used herein, “percolation” is used in the context of electron transfer and refers to “percolation threshold.” This is the minimum concentration of conductive particles required to form a continuous pathway for electron transport. The “percolation threshold” is a parameter that determines the efficiency of charge transport in various devices such as solar cells, batteries, and fuel cells.

As used herein, “pores” refers to an opening, in the context of a structure, that has a size range of about 1 nm to about 100 nm.

### REFERENCES

[1] a) J. Lu, Z. Chen, Z. Ma, F. Pan, L. A. Curtiss, K. Amine, Nature nanotechnology 2016, 11, 1031; b) X. Zeng, M. Li, D. Abd El-Hady, W. Alshitari, A. S. Al-Bogami, J. Lu, K. Amine, Advanced Energy Materials 2019, 9, 1900161; c) G. Harper, R. Sommerville, E. Kendrick, L. Driscoll, P. Slater, R. Stolkin, A. Walton, P. Christensen, O. Heidrich, S. Lambert, Nature 2019, 575, 75.
[2] R. Fakhry, S. Yeh, https://www.nrdc.org/sites/default/files/2030-biden-climate-pollution-ib.pdf 2021.
[3] Z. P. Cano, D. Banham, S. Ye, A. Hintennach, J. Lu, M. Fowler, Z. Chen, Nature Energy 2018, 3, 279.
[4] S. Evers, L. F. Nazar, Accounts of chemical research 2013, 46, 1135.
[5] X. Yang, X. Li, K. Adair, H. Zhang, X. Sun, Electrochemical Energy Reviews 2018, 1, 239.
[6] a) P. Zhu, C. Yan, J. Zhu, J. Zang, Y. Li, H. Jia, X. Dong, Z. Du, C. Zhang, N. Wu, Energy Storage Materials 2019, 17, 220; b) M. Nagao, A. Hayashi, M. Tatsumisago, Electrochimica Acta 2011, 56, 6055; c) X. Yao, N. Huang, F. Han, Q. Zhang, H. Wan, J. P. Mwizerwa, C. Wang, X. Xu, Advanced Energy Materials 2017, 7, 1602923; d) H. Nagata, Y. Chikusa, Journal of Power Sources 2014, 263, 141; e) L.-P. Hou, H. Yuan, C.-Z. Zhao, L. Xu, G.-L. Zhu, H.-X. Nan, X.-B. Cheng, Q.-B. Liu, C.-X. He, J.-Q. Huang, Energy Storage Materials 2020, 25, 436; f) Y. Zhang, T. Liu, Q. Zhang, X. Zhang, S. Wang, X. Wang, L. Li, L.-Z. Fan, C.-W. Nan, Y. Shen, Journal of Materials Chemistry A 2018, 6, 23345; g) Q. Zhang, N. Huang, Z. Huang, L. Cai, J. Wu, X. Yao, Journal of Energy Chemistry 2020, 40, 151.
[7] M. Agostini, Y. Aihara, T. Yamada, B. Scrosati, J. Hassoun, Solid State Ionics 2013, 244, 48.
[8] a) J. He, G. Hartmann, M. Lee, G. S. Hwang, Y. Chen, A. Manthiram, Energy & Environmental Science 2019, 12, 344; b) Y. You, Y. Ye, M. Wei, W. Sun, Q. Tang, J. Zhang, X. Chen, H. Li, J. Xu, Chemical Engineering Journal 2019, 355, 671.
[9] R. Chen, J. Shen, K. Chen, M. Tang, T. Zeng, Applied Surface Science 2021, 566, 150651.
[10] a) E. Cha, M. D. Patel, J. Park, J. Hwang, V. Prasad, K. Cho, W. Choi, Nature nanotechnology 2018, 13, 337; b) J. Fu, P. Yu, N. Zhang, G. Ren, S. Zheng, W. Huang, X. Long, H. Li, X. Liu, Energy & Environmental Science 2019, 12, 1404.
[11] L. Yu, Q. Su, B. Li, L. Huang, G. Du, S. Ding, W. Zhao, M. Zhang, B. Xu, Chemical Engineering Journal 2022, 429, 132479.
[12] A. KIzIlaslan, T. Çetinkaya, H. Akbulut, Advanced Materials Interfaces 2020, 7, 2001020.
[13] a) X. Geng, W. Sun, W. Wu, B. Chen, A. Al-Hilo, M. Benamara, H. Zhu, F. Watanabe, J. Cui, T.-p. Chen, Nature communications 2016, 7, 1; b) G. Eda, H. Yamaguchi, D. Voiry, T. Fujita, M. Chen, M. Chhowalla, Nano letters 2011, 11, 5111.
[14] Y. Pan, L. Gong, X. Cheng, Y. Zhou, Y. Fu, J. Feng, H. Ahmed, H. Zhang, ACS nano 2020, 14, 5917.
[15] C. Lu, W.-w. Liu, H. Li, B. K. Tay, Chemical Communications 2014, 50, 3338. [16] X. Sun, Q. Li, D. Cao, Y. Wang, A. Anderson, H. Zhu, Small 2021, 2105678.
[17] Y. Li, K. Chang, Z. Sun, E. Shangguan, H. Tang, B. Li, J. Sun, Z. Chang, ACS Applied Energy Materials 2019, 3, 998.
[18] K. Chang, X. Hai, H. Pang, H. Zhang, L. Shi, G. Liu, H. Liu, G. Zhao, M. Li, J. Ye, Advanced Materials 2016, 28, 10033.
[19] M. Chen, X. Yin, M. Reddy, S. Adams, Journal of Materials Chemistry A 2015, 3, 10698.
[20] X. Shan, S. Zhang, N. Zhang, Y. Chen, H. Gao, X. Zhang, Journal of colloid and interface science 2018, 510, 327.
[21] F. Xiong, Z. Cai, L. Qu, P. Zhang, Z. Yuan, O. K. Asare, W. Xu, C. Lin, L. Mai, ACS applied materials & interfaces 2015, 7, 12625.
[22] a) Y. Yu, G.-H. Nam, Q. He, X.-J. Wu, K. Zhang, Z. Yang, J. Chen, Q. Ma, M. Zhao, Z. Liu, Nature chemistry 2018, 10, 638; b) S. S. Chou, N. Sai, P. Lu, E. N. Coker, S. Liu, K. Artyushkova, T. S. Luk, B. Kaehr, C. J. Brinker, Nature communications 2015, 6, 1.
[23] Q. Tang, D.-e. Jiang, Chemistry of Materials 2015, 27, 3743.
[24] X. Geng, W. Sun, W. Wu, B. Chen, A. Al-Hilo, M. Benamara, H. Zhu, F. Watanabe, J. Cui, T.-p. Chen, Nat Commun 2016, 7.
[25] S. Shi, Z. Sun, Y. H. Hu, Journal of Materials Chemistry A 2018, 6, 23932.
[26] Y. Jiao, A. M. Hafez, D. Cao, A. Mukhopadhyay, Y. Ma, H. Zhu, Small 2018, 14, 1800640.
[27] D. Cao, Y. Zhang, A. M. Nolan, X. Sun, C. Liu, J. Sheng, Y. Mo, Y. Wang, H. Zhu, Nano letters 2019, 20, 1483.
[28] Y. Zhang, Y. Sun, L. Peng, J. Yang, H. Jia, Z. Zhang, B. Shan, J. Xie, Energy storage materials 2019, 21, 287.
[29] Y. Yang, X. Sun, Z. Cheng, A. Mukhopadhyay, A. Natan, C. Liu, D. Cao, H. Zhu, ACS Applied Energy Materials 2020, 3, 6249.
[30] J. Auvergniot, A. Cassel, J.-B. Ledeuil, V. Viallet, V. Seznec, R. Dedryvère, Chemistry of Materials 2017, 29, 3883.
[31] J. Auvergniot, A. Cassel, D. Foix, V. Viallet, V. Seznec, R. Dedryvère, Solid State Ionics 2017, 300, 78.
[32] a) D. H. Tan, E. A. Wu, H. Nguyen, Z. Chen, M. A. Marple, J.-M. Doux, X. Wang, H. Yang, A. Banerjee, Y. S. Meng, ACS Energy Letters 2019, 4, 2418; b) Y. Zhu, X. He, Y. Mo, ACS Applied Materials & Interfaces 2015, 7, 23685.
[33] a) M. Chen, S. Adams, Journal of Solid State Electrochemistry 2015, 19, 697; b) K. Suzuki, D. Kato, K. Hara, T.-a. Yano, M. Hirayama, M. Hara, R. Kanno, Electrochimica Acta 2017, 258, c) 110; U. Ulissi, S. Ito, S. M. Hosseini, A. Varzi, Y. Aihara, S. Passerini, Advanced Energy Materials 2018, 8, 1801462; d) J. Nguyen, B. Fleutot, R. Janot, Solid State Ionics 2018, 315, 26.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments.

1. A MoS₂@polyacrylonitrile-derived porous carbon fiber core-shell structure, comprising:
a core comprising polyacrylonitrile-derived porous carbon fibers (PPCF) with surface layer pores; and
a shell comprising a MoS₂ nanosheet that is uniformly distributed on the surface of the core.

2. The MoS₂@polyacrylonitrile-derived porous carbon fiber core-shell structure of claim 1, wherein the MoS₂ nanosheet is vertically grown.

3. The MoS₂@polyacrylonitirile derived porous carbon fiber core-shell structure of claim 1, wherein the core-shell structure may be used as an electrode in a battery.

4. The MoS₂@polyacrylonitirile derived porous carbon fiber core-shell structure of claim 3, wherein the electrode is a cathode.

5. The MoS₂@polyacrylonitrile-derived porous carbon fiber core-shell structure of claim 1, wherein lithium ions are intercalated within layers of the MoS₂ nanosheets.

6. The MoS₂@polyacrylonitrile-derived porous carbon fiber core-shell structure of claim 1, wherein the MoS₂ nanosheet is a 2H MOS₂ nanosheet, a 1T MoS₂ nanosheet, or a hybrid 1T/2H MOS₂ nanosheet.

7. The MoS₂@polyacrylonitrile-derived porous carbon fiber core-shell structure of claim 1, wherein the core polyacrylonitrile-derived porous carbon fibers comprise a high surface area density of pores.

8. The MoS₂@polyacrylonitrile-derived porous carbon fiber core-shell structure of claim 7, wherein the surface area density is about 1000 m²/g to about 2000 m²/g.

9. An all-solid-state lithium-sulfur battery comprising the MoS₂@polyacrylonitrile-derived porous carbon fiber core-shell structure of claim 1.

10. The all-solid-state lithium-sulfur battery of claim 9 further comprising a solid-state electrolyte.

11. The all-solid-state lithium-sulfur battery of claim 10, wherein the solid-state electrolyte is Li_{5.6}PS_{4.4}Cl_{1.6}.

12. The all-solid-state lithium-sulfur battery of claim 9, wherein the battery has an initial discharge capacity is about 900 mAh/g to about 1600 mAh/g.

13. The all-solid-state lithium-sulfur battery of claim 9, wherein the battery has a Coulombic efficiency of about 97% to about 100%.

14. The all-solid-state lithium-sulfur battery of claim 9, wherein the battery has a capacity retention of about greater than or equal to 70% retention.

15. The all-solid-state lithium-sulfur battery of claim 9, wherein the battery has a discharge capacity of about 900 mAh/g to about 1600 mAh/g.

16. A method of preparing a MoS₂@polyacrylonitrile-derived porous carbon fiber core-shell structure, the method comprising:
a) dispersing polyacrylonitrile-derived porous carbon fibers (PPCF) in water and sonicating, thereby making a PPCF dispersion;
b) mixing MoO₃, thioacetamide, and urea with the PPCF dispersion, thereby forming a MoS₂ and PPCF mixture; and
c) sintering the MoS₂ and PPCF mixture, thereby forming MoS₂@PPCF.

17. The method of claim 16, wherein sintering the MoS₂ and PPCF mixture was performed for about 15 hours to about 20 hours at about 60° C. to about 200° C.

18. A method of preparing an all-solid-state lithium sulfur battery, the method comprising:
a) mixing and heating polyacrylonitrile-derived porous carbon fibers (PPCF), sulfur, and lithium electrolyte, thereby forming a battery cathode; and
b) cold pressing the battery cathode, lithium electrolyte, and a lithium-indium anode together, thereby forming an all-solid-state lithium sulfur battery.

19. The method of claim 18, wherein the battery cathode further comprises MoS₂@PPCF.

20. The method of claim 18, wherein the lithium electrolyte is a solid electrolyte comprising Li_{5.4}PS_{4.4}Cl_{1.6}.
